(19) United States
(12) Patent Application Publication
(10) Pub. No.: US 2010/0318485 A1
(43) Pub. Date: Dec. 16, 2010

(54) INFORMATION DISTRIBUTION APPARATUS, INFORMATION DISTRIBUTION SYSTEM, METHOD AND PROGRAM

(75) Inventors: Shin Harada, Minato-ku (JP); Shinya Ishikawa, Minato-ku (JP); Takashi Shiraki, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-Ku, Tokyo (JP)

(21) Appl. No.: 12/867,205

(22) PCT Filed: Feb. 9, 2009
(86) PCT No.: PCT/JP2009/052185

§ 371 Date: Aug. 11, 2010

(30) Foreign Application Priority Data
Feb. 12, 2008 (JP) 2008-030504

(51) Int. Cl. G06N 5/02; G06F 15/16; G06F 17/30

(52) U.S. Cl. 706/46; 709/217; 707/802; 707/E17.005

(57) ABSTRACT

An information distribution system which can distribute information efficiently. The information distribution apparatus (300) identifies an intermediary (200) for distributing information to the terminal (100) of the party to whom the information is to be distributed. Subsequently, a request to distribute information to the terminal (100) of the party to whom the information is to be distributed is submitted to the terminal (200) of the identified intermediary. Therein, the information distribution apparatus (300) selects a party who has a relationship with the party to whom the information is to be distributed as the intermediary (200).

An information distribution system capable of performing an efficient information distribution is provided.

### TECHNICAL FIELD

The present invention relates to a technology which distributes information to a user, and in particular, relates to a technology which enables information distribution, via a user (introducer) who has a relationship with a user to whom information is desired to be distributed (information distribution target person), to an information distribution target person.

### BACKGROUND ART

In recent years, on the internet, information distribution is frequently performed. However, distribution origin which distributes information to a user is often a third party without a direct relationship with the user. For this reason, even if information is distributed directly from the third party, in reality, the user does not view the distributed information often.

For this reason, development of a system which improves a probability a user views information and which performs efficient information distribution is regarded as necessary.

Further, as technical literature which is applied prior to the present invention, there is a document which discloses a technology which makes good use of an internet shipping site secondarily and enables the online shopping to be used more actively and effectively (for example, refer to Patent Document 1).

The above-mentioned Patent Document 1 presents a merchandise list on a user's terminal responding to a demand by the user accessing via a communication line, and stores goods which the user selected from the merchandise list in a customer file as a favorite merchandise list. And based upon user's request, notifies a user's acquaintance of the favorite merchandise list stored in the customer file. As a result, by notifying a close acquaintance of the user's taste, it becomes possible for an operator of an online shopping site to get efficient advertising effects. Also, a message created by a user is notified to an acquaintance as well as a favorite merchandise list, asking the acquaintance to send goods to the user (coaxing function), or introducing goods to the acquaintance by word-of-mouth communication and encouraging acquaintance's purchase (word-of-mouth communication function).

Also, there is a document which discloses a technology which provides highly precise recommended programs information (for example, refer to Patent Document 2).

The above-mentioned Patent Document 2 transmits recommended programs information issued by a certain user through friend relationships.

[Patent Document 1] Japanese Patent Application Laid-Open No. 2002-312613

[Patent Document 2] Japanese Patent Application Laid-Open No. 2007-158925

### SUMMARY OF INVENTION

### Technical Problem

Further, a point is disclosed in the above-mentioned Patent Document 1 in which a favorite merchandise list that a user has selected is notified to an acquaintance of the user, and goods are sent to the user from the acquaintance. However, an act of an acquaintance sending goods to the user is not frequently done. For this reason, by the technology of the above-mentioned Patent Document 1, an activation of communication between the user and the acquaintance cannot be achieved.

Also, a point is disclosed in the above-mentioned Patent Document 2 which transmits recommended programs information through friend relationships. However, by the above-mentioned Patent Document 2, recommended programs information is transmitted using a friends list registered on a mobile terminal. For this reason, in the technology of the above-mentioned Patent Document 2, recommended programs information can be transmitted only to a friend on a friends list registered on each mobile terminal in advance. Consequently, seen from a distribution origin who wants to distribute information, if an information distribution target person to whom he wants to distribute information is not registered in a friends list, information transmission to the information distribution target person does not occur. Accordingly, by the technology of the above-mentioned Patent document 2, efficient information distribution cannot be performed.

Neither, points are described nor their necessity is suggested in the above-mentioned Patent Documents 1 and 2 which decide the most suitable introducer who distributes information to an information distribution target person, and request the decided introducer concerned, information distribution to the information distribution target person.

The present invention is made in view of the above-mentioned circumstances and has the object of providing an information distribution device, a terminal, an information distribution system, a method and a program capable of performing efficient information distribution which is the problem mentioned above.

### Solution to Problem

In order to achieve the object, the present invention has the following characteristics.

<Information Distribution Device>

An information distribution device according to the present invention is characterized by comprising:

a decision means which decides an introducer who distributes information to a terminal of an information distribution target person, and

a distribution means which requests a terminal of an introducer who is decided by said decision means, information distribution to a terminal of said information distribution target person, wherein

said decision means

decides a related person who has a relationship with said information distribution target person as an introducer.

<Terminal>

Further, a terminal according to the present invention is

a terminal of an introducer which distributes information to an information distribution target person, and is characterized by comprising:

an introduction notification display means which displays an introduction notification including information on said information distribution target person and distribution information to be distributed to the information distribution target person concerned, and

a distribution means which, in case distribution operation of said introduction notification is performed after said introduction notification is displayed by said introduction notification display means, distributes at least one information of said distribution information and a list ID for specifying said introduction notification, to a terminal of an information distribution target person included in said introduction notification.

Further, a terminal according to the present invention is

a terminal of an introducer which distributes information to an information distribution target person, and is characterized by comprising:

a introduction notification display means which displays an introduction notification including information on said information distribution target person and distribution information to be distributed to the information distribution target person concerned, and

a registration means which, in case distribution operation of said introduction notification is performed after said introduction notification is displayed by said introduction notification display means, registers at least one information of said distribution information and a list ID for specifying said introduction notification, to an introduction information management means by correlating to information on said information distribution target person.

<Information Distribution System>

Further, an information distribution system according to the present invention is

an information distribution system characterized by being configured as to comprise a terminal and an information distribution device, wherein

said information distribution device comprises:

a decision means which decides an introducer who distributes information to a terminal of an information distribution target person, and

a distribution means which requests a terminal of an introducer who is decided by said decision means, information distribution to a terminal of said information distribution target person; wherein

said decision means

decides a related person who has a relationship with said information distribution target person as an introducer.

<Information Distribution Method>

Further, an information distribution method according to the present invention is characterized by comprising:

a decision step in which decides an introducer who distributes information to a terminal of an information distribution target person, and

a distribution step which requests a terminal of an introducer who is decided by said decision step, information distribution to a terminal of said information distribution target person; wherein

said decision step in which

decides a related person who has a relationship with said information distribution target person as an introducer.

<Information Distribution Program>

Further, an information distribution program according to the present invention is characterized by making a computer execute

a decision processing in which decides an introducer who distributes information to a terminal of an information distribution target person, and

a distribution processing in which requests a terminal of, an introducer who is decided by said decision processing, information distribution to a terminal of said information distribution target person; wherein

said decision processing in which

decides a related person who has a relationship with said information distribution target person as an introducer.

<Method>

Further, a method according to the present invention is characterized by comprising:

an introduction notification display step in which displays on a display means, an introduction notification including information on an information distribution target person and distribution information to be distributed to the information distribution target person concerned, and

a distribution step in which, in case distribution operation of said introduction notification is performed after said introduction notification is displayed on said display means by said introduction notification display step, distributes at least one information of said distribution information and a list ID for specifying said introduction notification, to a terminal of an information distribution target person included in said introduction notification.

Further, a method according to the present invention is characterized by comprising:

an introduction notification display step in which displays on a display means, an introduction notification including information on an information distribution target person and distribution information to be distributed to the information distribution target person concerned, and

a registration step in which, in case distribution operation of said introduction notification is performed after said introduction notification is displayed on said display means by said introduction notification display step, registers at least one information of said distribution information and a list ID for specifying said introduction notification, to an introduction information management means by correlating to information on said information distribution target person.

<Program>

Further, a program according to the present invention is characterized by making a computer execute

an introduction notification display processing in which displays on a display means, an introduction notification including information on an information distribution target person and distribution information to be distributed to the information distribution target person concerned, and

a distribution processing in which, in case distribution operation of said introduction notification is performed after said introduction notification is displayed on said display means by said introduction notification display processing, distributes at least one information of said distribution information and a list ID for specifying said introduction notification, to a terminal of an information distribution target person included in said introduction notification.

Further a program according to the present invention is characterized by making a computer execute

an introduction notification display processing in which displays on a display means, an introduction notification including information on an information distribution target person and distribution information to be distributed to the information distribution target person concerned, and

a registration processing in which, in case distribution operation of said introduction notification is performed after said introduction notification is displayed on said display means by said introduction notification display processing, registers at least one information of said distribution information and a list ID for specifying said introduction notification, to an introduction information management means by correlating to information on said information distribution target person.

### Effects of Invention

According to the present invention, efficient information distribution can be performed.

### MOST PREFERRED MODE FOR CARRYING OUT THE INVENTION

<Outline of an Information Distribution System>

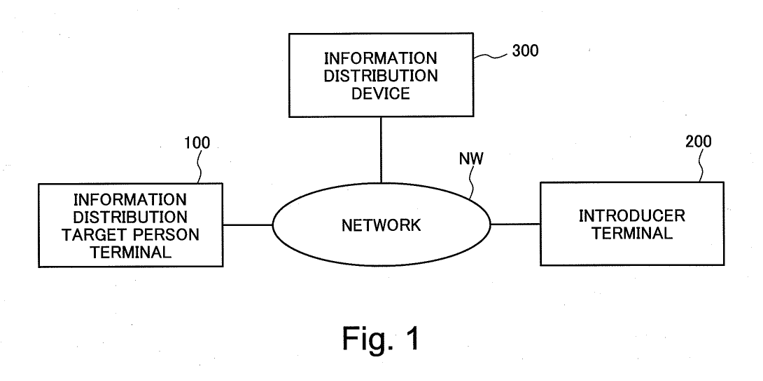

First, an outline of an information distribution system of this exemplary embodiment is described with reference to FIG. 1.

As shown in FIG. 1, an information distribution system of this exemplary embodiment is an information distribution system which is configured as to include terminals (information distribution target person terminal: 100 and introducer terminal: 200) and an information distribution device (300). And an information distribution device (300) decides an introducer (200) who distributes information to a terminal (100, for example) of an information distribution target person. And an information distribution device (300) requests to a terminal of the decided introducer (200), information distribution to a terminal (100) of an information distribution target person. Further, an information distribution device (300) decides a related person who has a relationship with an information distribution target person (100) as an introducer (200).

Accordingly, an information distribution device (300) can decide the most suitable introducer (200) who distributes information to a terminal (100) of an information distribution target person and can request to the decided introducer concerned (200), information distribution to a terminal (100) of an information distribution target person. As a result, when an introducer (200) performs information distribution to a terminal (100) of an information distribution target person according to a distribution request from an information distribution device (300), an information distribution target person (100) receives information from an introducer (200) who has a relationship with an information distribution target person (100) himself. Further, because information is distributed from an introducer (200) who has a relationship with an information distribution target person (100) himself, an information distribution target person (100) will have an interest in the information and view the information. As a result, an information distribution system of this exemplary embodiment can improve probability an information distribution target person (100) views information and can perform an efficient information distribution. Further, because a certain relationship exists between an information distribution target person (100) and an introducer (200), with information distribution to an information distribution target person (100) as an trigger, an activation of communication between the introducer (200) and the information distribution target person (100) can be achieved. Hereinafter, an information distribution system of this exemplary embodiment is described in detail with reference to accompanying drawings.

### The First Exemplary Embodiment

<Information Distribution System>

First, a system configuration of an information distribution system of this exemplary embodiment is described with reference to FIG. 1.

An information distribution system of this exemplary embodiment includes an information distribution target person terminal (100), an introducer terminal (200) and an information distribution device (300) connected via a network (NW).

Further, as for a network (NW) of this exemplary embodiment, a communication configuration is not limited specifically, and any communication configurations are applicable regardless of wired or wireless, as far as information communication between each device is possible.

<Information Distribution Target Person Terminal: 100>

An information distribution target person terminal (100) is a terminal which a user who becomes an information distribution target person uses. An information distribution target person is an end user to whom information distributed from an information distribution device (300) is desired to be distributed finally.

<Introducer Terminal: 200>

An introducer terminal (200) is a terminal which a user who becomes an introducer uses. An introducer is a user who has a certain relationship with an information distribution target person. According to this exemplary embodiment, information is distributed to an information distribution target person via this introducer.

<Information Distribution Device: 300>

An information distribution device (300) is a device which distributes information to an information distribution target person via an introducer. An information distribution device (300) of this exemplary embodiment decides an introducer who distributes information to an information distribution target person and requests to the decided introducer concerned, information distribution to an information distribution target person.

<Internal Configuration of Information Distribution Device: 300>

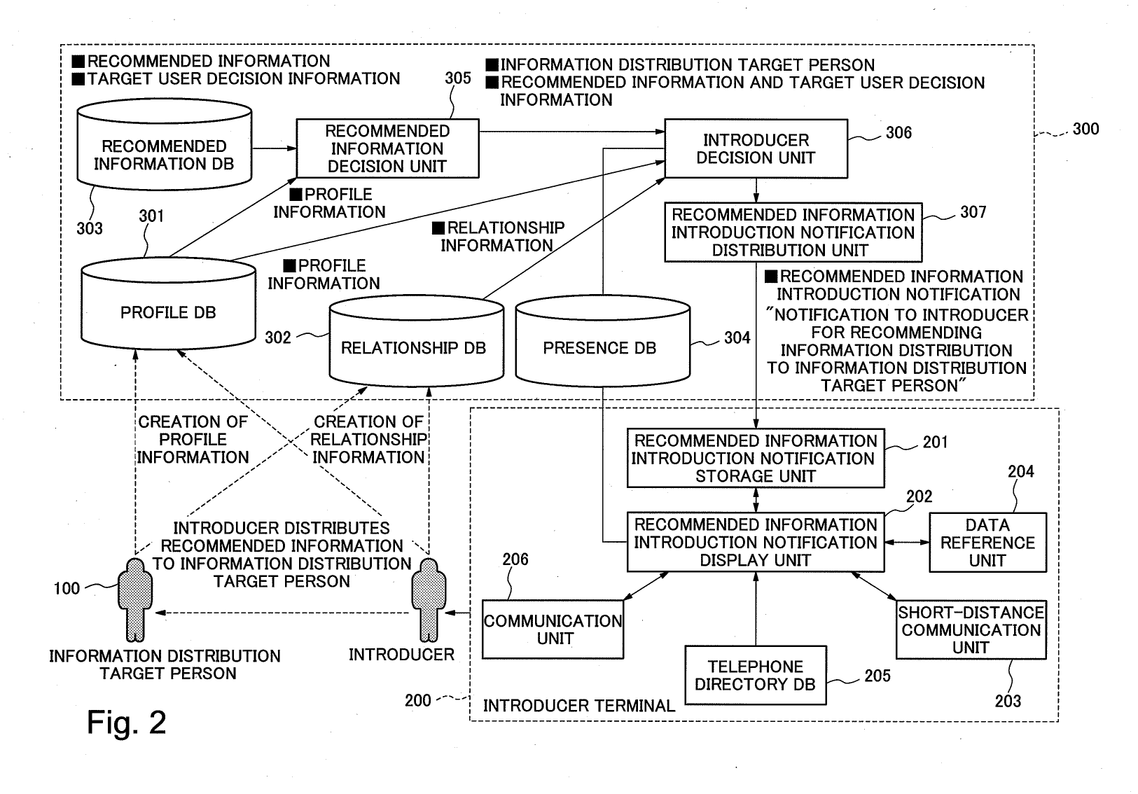

Next, an internal configuration of an information distribution device (300) of this exemplary embodiment is described with reference to FIG. 2.

An information distribution device (300) of this exemplary embodiment is configured as to include a profile DB (301), a relationship DB (302), a recommended information DB (303), a presence DB (304), a recommended information decision unit (305), an introducer decision unit (306) and a recommended information introduction notification distribution unit (307).

<Profile DB: 301>

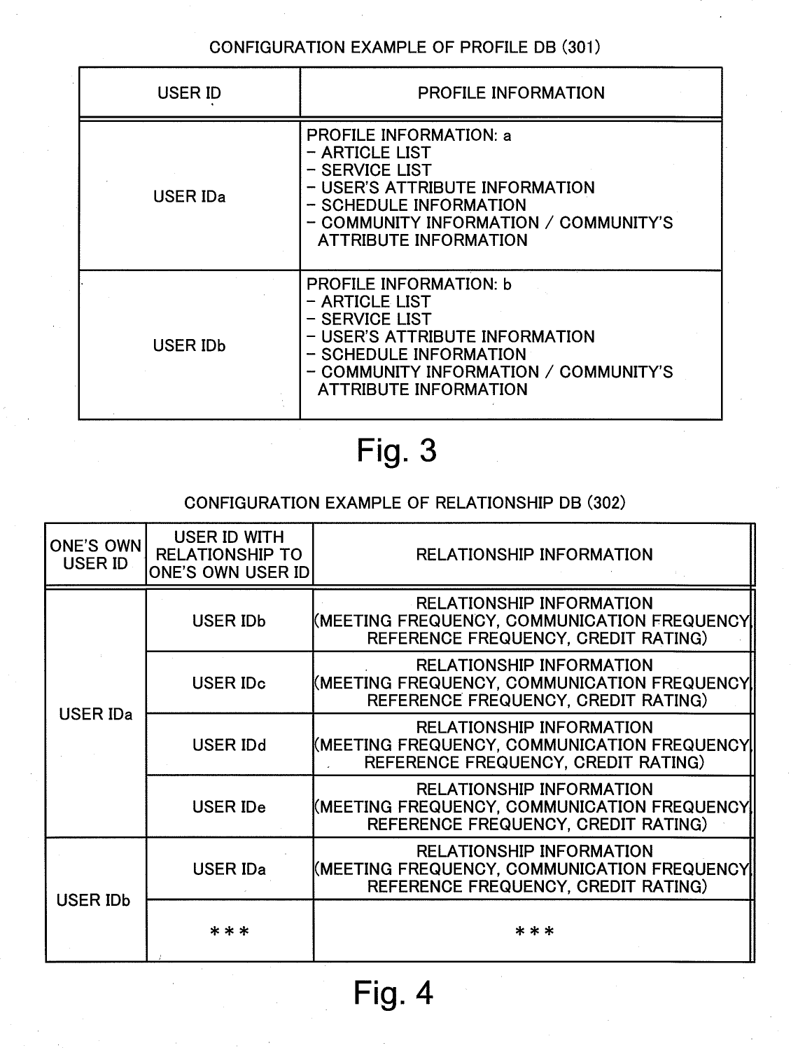

A profile DB (301) manages user's profile information and manages profile information for each user. According to this exemplary embodiment, as shown in FIG. 3, profile information is managed for each user ID. A user ID is information for specifying a user uniquely. In this exemplary embodiment, it is desirable to apply to a user ID information such as a telephone number, a mail address, a MAC address or a private ID capable of specifying a user uniquely when communicating. Further, as profile information, following information can be mentioned.

<Profile Information>

An article list which a user possesses (information on books, CD's, clothes, electrical appliances and so on).

A service list which a user is using (information on various services which a user uses such as a sports club or a video rental).

Attribute information for specifying characteristics of a user (tag information such as sex, age, a job category, an address, a form and a hobby).

Schedule information for specifying a user's schedule (scheduled items such as an appointment with Mr. X on such and such a day).

Information on a community which a user joins (information on a community registered on the internet) and attribute information for specifying the community.

Further, as attribute information for specifying a community, tag information for specifying the genre (such as sport, music, economy and study) of the community can be mentioned.

Further, a creation method of profile information managed in a profile DB (301) is not limited specifically, and as far as profile information mentioned above can be managed for each user, any methods are applicable. For example, there is a method in which a user inputs profile information to a profile DB (301) directly. There is another method in which a service provider inputs profile information to a profile DB (301). Further, there is yet another method in which, when a user accesses an information distribution device (300), the information distribution device (300) creates profile information based on information which the information distribution device (300) acquired from the user accompanying the access, and inputs the created profile information concerned to a profile DB (301).

Further, in the above-mentioned profile DB (301), information on a community and attribute information for specifying the community are correlated and managed (community information/community's attribute information). However, it is also possible to construct by managing community information and a community ID for specifying the community only (community information/community ID) in a profile DB (301) and, based on the community ID, acquiring attribute information on the community corresponding to the community ID from a network.

<Relationship DB: 302>

A relationship DB (302) manages relationship information between users and manages relationship information for each user. According to this exemplary embodiment, as shown in FIG. 4, relationship information with other user ID's is managed for each user ID. Relationship information is information which indicates a relationship between users, and following information can be mentioned as relationship information. Further, the following information indicates relationship information which is being managed for user IDa and, in particular, indicates an example of relationship information between user IDa and user IDb.

<Relationship Information>

Frequency that user IDa meets with user IDb directly (meeting frequency).

Frequency that user IDa communicates with user IDb through communication of such as a telephone, a mail and a message (communication frequency).

Frequency that user IDa refers to public information of user IDb (reference frequency).

Degree of evaluation and reliability of user IDb by user IDa (credit rating).

Further, although the above-mentioned relationship information indicates only relationship information between user IDa and user IDb, when a plurality of relationship information on user IDa exist, as shown in FIG. 4, relationship information with other user ID's such as user IDc, IDd and IDe is also managed.

Further, sample calculation methods of meeting frequency, communication frequency, reference frequency and credit rating mentioned above are described below.

(Meeting Frequency)

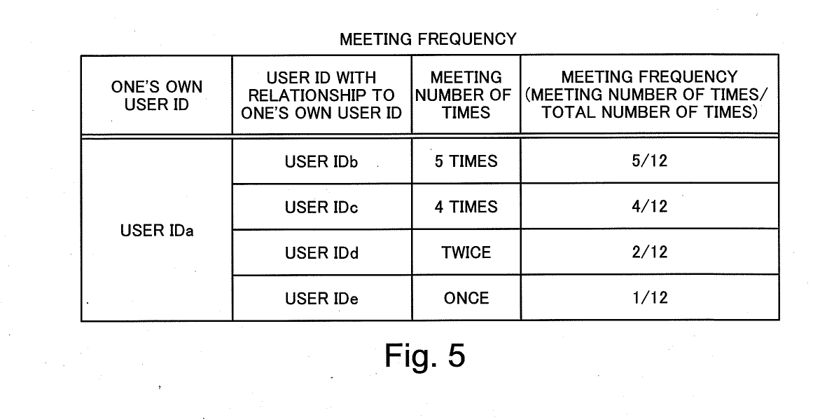

By using information managed in a presence DB (304) (user's location information), when user IDa and user IDb are detected to have approached within the range of a certain fixed distance, it is judged that user IDa and user IDb have met directly, and meeting number of times between user IDa and user IDb is incremented by 1 count. And as shown in FIG. 5, counted meeting number of times is managed for each user ID. And meeting frequency for each user ID is calculated using the following (formula 1) based on the TOTAL number of times of the meeting number of times managed for each user ID.

Meeting frequency=meeting number of times for each user ID/TOTAL number of times (formula 1)

By applying the above (formula 1), in case of information shown in

FIG. 5,

Meeting frequency with user IDb= 5/12

Meeting frequency with user IDc= 4/12

Meeting frequency with user IDd= 2/12

Meeting frequency with user IDe= 1/12.

Further, above-mentioned meeting frequencies with users IDb-IDe are managed as relationship information on user IDa shown in FIG. 4.

(Communication Frequency)

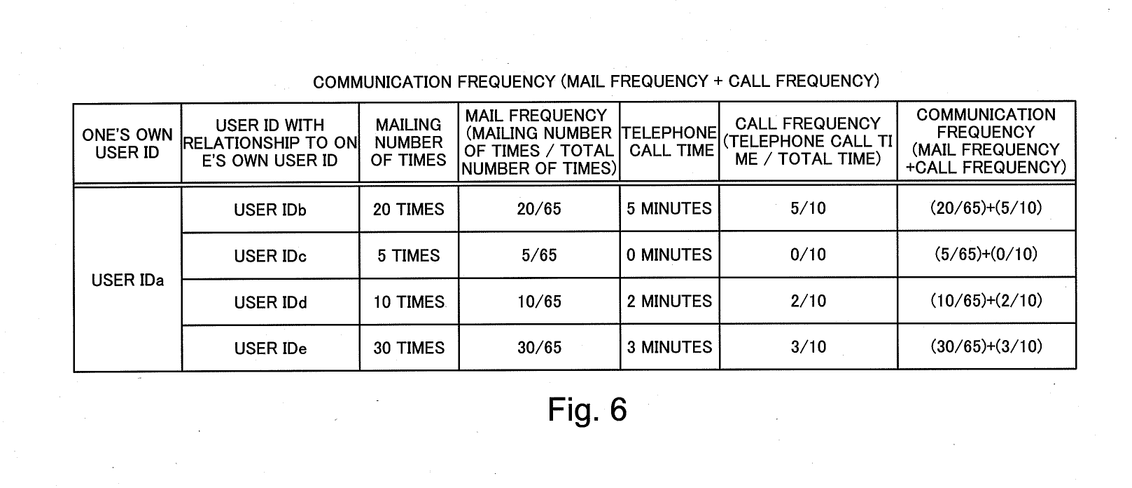

A total of the number of transmission and the number of reception of mails (mailing number of times) are managed for each user ID as shown in FIG. 6. Also for a telephone call, call time is managed for each user ID as shown in FIG. 6. And mail frequency for each user ID is calculated using the following (formula 2) based on the TOTAL number of times of the mailing number of times managed for each user ID.

Mail frequency=mailing number of times for each user ID/TOTAL number of times (formula 2)

By applying the above (formula 2), in case of information shown in FIG. 6,

Mail frequency with user IDb= 20/65

Mail frequency with user IDc= 5/65

Mail frequency with user IDd= 10/65

Mail frequency with user IDe= 30/65.

Also, call frequency for each user ID is calculated using the following (formula 3) based on the TOTAL time of the telephone call time for each user ID.

Call frequency=telephone call time for each user ID/TOTAL time (formula 3)

By applying the above (formula 3), in case of information shown in FIG. 6,

Call frequency with user IDb= 5/10

Call frequency with user IDc= 0/10

Call frequency with user IDd= 2/10

Call frequency with user IDe= 3/10.

Next, communication frequency is calculated for each user using the following (formula 4) based on the mail frequency calculated by the above (formula 2) and the call frequency calculated by the above (formula 3).

Communication frequency=mail frequency+call frequency (formula 4)

By applying the above (formula 4), in case of information shown in FIG. 6,

Communication frequency with user IDb=( 20/65)+( 5/10)

Communication frequency with user IDc=( 5/65)+( 0/10)

Communication frequency with user IDd=( 10/65)+( 2/10)

Communication frequency with user IDe=( 30/65)+( 3/10).

Further, above-mentioned communication frequencies with users IDb-IDe are managed as relationship information on user IDa shown in FIG. 4.

(Reference Frequency)

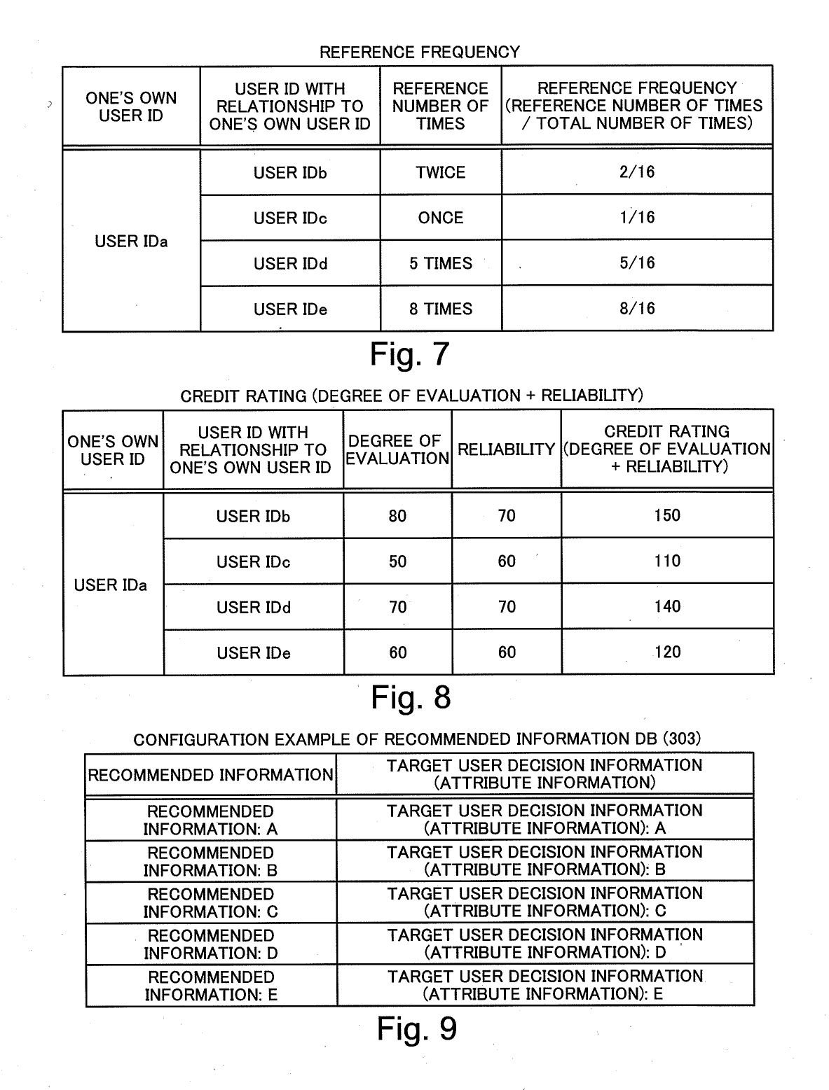

When user IDa refers to public information of user IDb (such as home page or blog), reference number of times of user IDb is incremented by 1 count, and as shown in FIG. 7, counted reference number of times is managed for each user ID. And reference frequency for each user ID is calculated using the following (formula 5) based on the TOTAL number of times of the reference number of times for each user ID.

Reference frequency=reference number of times for each user ID/TOTAL number of times (formula 5)

By applying the above (formula 5), in case of information shown in FIG. 7,

Reference frequency of user IDb= 2/16

Reference frequency of user IDc= 1/16

Reference frequency of user IDd= 5/16

Reference frequency of user IDe= 8/16.

Further, above-mentioned reference frequencies of users IDb-IDe are managed as relationship information on user IDa shown in FIG. 4.

(Credit Rating)

User IDa determines degree of evaluation and reliability of user IDb, and credit rating is calculated using the following (formula 6) based on the determined degree of evaluation and reliability.

Credit rating=degree of evaluation+reliability (formula 6)

By using the above (formula 6), as shown in FIG. 8, it becomes possible to manage credit rating of each user IDb-IDe. Further, credit ratings of users IDb-IDe shown in FIG. 8 are managed as relationship information on user IDa shown in FIG. 4.

Further, a creation method of above-mentioned relationship information managed in a relationship DB (302) is not limited specifically, and as far as relationship information mentioned above can be managed for each user ID, any methods are applicable. For example, there is a method in which a user inputs relationship information to a relationship DB (302) directly. There is another method in which a service provider inputs relationship information to a relationship DB (302). Further, there is yet another method in which, when a user accesses an information distribution device (300) and exchanges information with other users, based on information acquired from the user accompanying the information exchanges, the information distribution device (300) creates relationship information and inputs the created information concerned to a relationship DB (302).

<Recommended Information DB: 303>

As shown in FIG. 9, a recommended information DB (303) relates recommended information and target user decision information and manages them. Recommended information is information distributed to a user, and as an example, various information like advertisement, messages and so on can be mentioned. Recommended information is, if it is information desired to be distributed to a user, not limited specifically and any information can be managed in a recommended information DB (303) as recommended information.

Target user decision information is information for deciding an information distribution target person to whom recommended information is desired to be distributed, and attribute information or the like can be mentioned. As attribute information, information related to recommended information (information such as genre or contents of recommended information) and tag information such as sex, age, a job category or an area to which recommended information is desired to be distributed can be mentioned. Attribute information is, if it is information capable of specifying an information distribution target person to whom recommended information is desired to be distributed, any information can be applied as attribute information.

A creation method of recommended information managed in a recommended information DB (303) and target user decision information are not limited specifically, and as far as recommended information and target user decision information can be related and managed, any methods are applicable.

<Presence DB: 304>

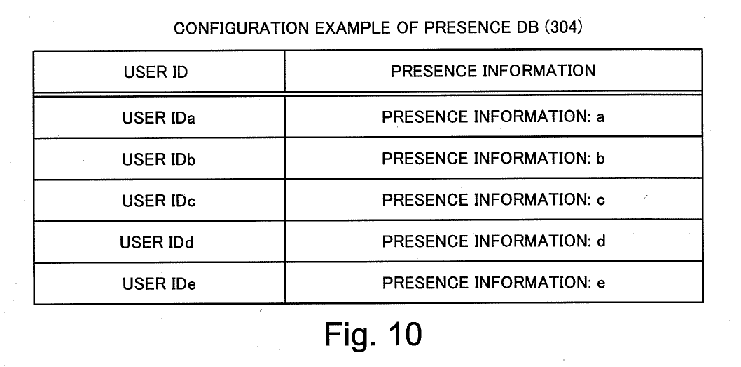

A presence DB (304) manages user's presence information (such as present communication state and location information). According to this exemplary embodiment, as shown in FIG. 10, presence information is managed for each user ID. Information managed in a presence DB (304) of this exemplary embodiment applies a publicly known presence technology and manages presence information on each user.

<Recommended Information Decision Unit: 305>

A recommended information decision unit (305) decides an information distribution target person who becomes a distribution target of recommended information using “recommended information” and “target user decision information” managed in a recommended information DB (303) shown in FIG. 9, and “profile information” managed in a profile DB (301) shown in FIG. 3.

<Introducer Decision Unit: 306>

An introducer decision unit (306) decides an introducer who has a relationship with an information distribution target person using “recommended information” and “target user decision information” managed in a recommended information DB (303) shown in FIG. 9, “profile information” managed in a profile DB (301) shown in FIG. 3 and “relationship information” managed in a relationship DB (302) shown in FIG. 4. According to this exemplary embodiment, information distribution to an information distribution target person is requested to an introducer who is decided by this introducer decision unit (306).

<Recommended Information Introduction Notification Distribution Unit: 307>

A recommended information introduction notification distribution unit (307) distributes a recommended information introduction notification to an introducer who is decided by an introducer decision unit (306). A recommended information introduction notification is information for requesting an introducer to introduce recommended information to an information distribution target person. A recommended information introduction notification includes recommended information, information on an information distribution target person (including user ID) and a message for suggesting an introducer to introduce recommended information. It is also possible to include in a recommended information introduction notification, information such as a reason why recommended information is introduced to an information distribution target person.

<Internal Configuration of Introducer Terminal: 200>

Next, an internal configuration of an introducer terminal (200) of this exemplary embodiment is described with reference to FIG. 2.

An introducer terminal (200) of this exemplary embodiment is configured as to include a recommended information introduction notification storage unit (201), a recommended information introduction notification display unit (202), a short-distance communication unit (203), a data reference unit (204), a telephone directory DB (205) and a communication unit (206).

<Recommended Information Introduction Notification Storage Unit: 201>

A recommended information introduction notification storage unit (201) stores a recommended information introduction notification distributed from an information distribution device (300).

<Recommended Information Introduction Notification Display Unit: 202>

A recommended information introduction notification display unit (202) presents a recommended information introduction notification stored in a recommended information introduction notification storage unit (201) to an introducer.

<Short-Distance Communication Unit: 203>

A short-distance communication unit (203) performs short-distance communication with a communication partner. As short-distance communication, such as wireless communication, infrared communication, Bluetooth and visible optical communication can be mentioned.

<Data Reference Unit: 204>

A data reference unit (204) is used when an introducer refers to various data, and for example, a web browser and so on can be mentioned.

<Telephone Directory DB: 205>

A telephone directory DB (205) manages, when communicating using an introducer terminal (200), information on a user who becomes the communication partner. A telephone directory DB (205) relates user's information to a user ID and manages it.

<Communication Unit: 206>

A communication unit (206) communicates with a communication partner.

<Processing Operation in an Information Distribution System>

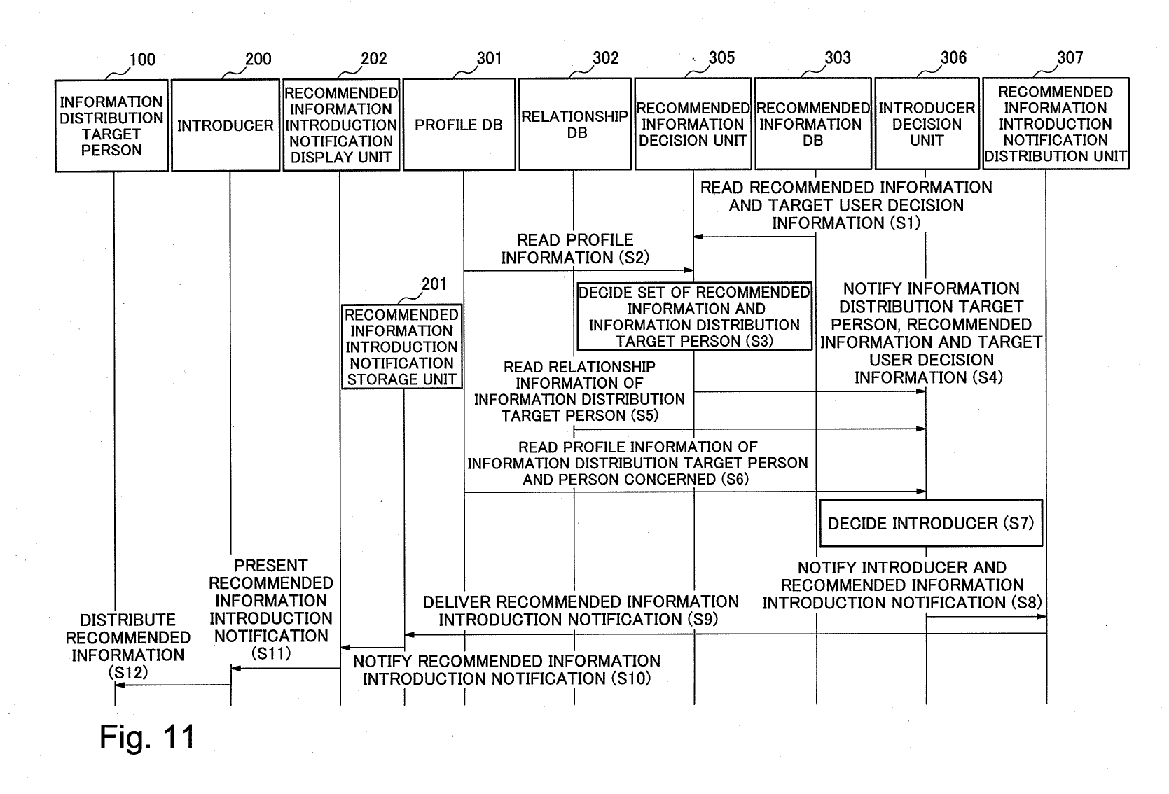

Next, processing operation in an information distribution system of this exemplary embodiment is described with reference to FIG. 11. Further, FIG. 11 is a figure showing a series of processing operations in an information distribution system.

<Decision Method of a Set of Recommended Information and an Information Distribution Target Person>

First, a decision method of a set of recommended information and an information distribution target person is described.

First, a recommended information decision unit (305) refers to a recommended information DB (303) shown in FIG. 9 and acquires information on a set of recommended information and a target user decision information from a recommended information DB (303) (Step S1). Also, a recommended information decision unit (305) refers to a profile DB (301) shown in FIG. 3 and acquires profile information from a profile DB (301) (Step S2).

Next, a recommended information decision unit (305) compares target user decision information acquired from a recommended information DB (303) and profile information acquired from a profile DB (301), specifies a user (user ID) with profile information which has a relationship with target user decision information, and decides the user (user ID) specified as an information distribution target person (Step S3). Further, an information distribution target person is an end user to whom recommended information is desired to be distributed finally.

Further, as a method to specify a user (user ID) with profile information which has a relationship with target user decision information, for example, a method which compares attribute information of target user decision information and attribute information of profile information, and specifies the user (user ID) with profile information which has attribute information related to attribute information of target user decision information can be mentioned.

Specifically, similarity measure is calculated for each user ID to specify how well attribute information of target user decision information and attribute information of profile information agree. As a calculation example of similarity measure, there is a method which, when there exist five attribute information in target user decision information and five attribute information in profile information, and when there are two attribute information which agree among each attribute information, calculates as similarity measure=⅖. A calculation method of similarity measure is not limited specifically, and any publicly known calculation methods are applicable. Next, based on similarity measure calculated for each user ID, a user ID with the highest similarity measure is specified and the specified user ID is decided as an information distribution target person to whom recommended information is distributed. Also, based on similarity measure calculated for each user ID, user ID's of similarity measures no smaller than a predetermined threshold value are specified and the specified user ID's are decided as information distribution target persons.

As a result, a recommended information decision unit (305) decides the set of recommended information and an information distribution target person to whom recommended information is distributed, using recommended information and target user decision information managed in a recommended information DB (303) shown in FIG. 9, and profile information managed in a profile DB (301) shown in FIG. 3.

Further, in the above-mentioned processing, although a recommended information decision unit (305) refers to a recommended information DB (303) shown in FIG. 9 and acquires information on a set of recommended information and target user decision information from a recommended information DB (303), as the acquisition method, the following method can be applied. For example, when new recommended information is registered in a recommendation DB (303), the effect that the new recommended information is registered and recommended information ID for specifying the new recommended information are notified to a recommended information decision unit (305). A recommended information decision unit (305), when received the effect that new recommended information is registered and recommended information ID, based on the recommended information ID, refers to a recommendation DB (303) and acquires information on a set of the new recommended information correlated to the recommended information ID and the target user decision information of the recommended information from the recommendation DB (303). As a result, a recommended information decision unit (305) can specify recommended information newly registered in a recommendation DB (303) and can decide a set of the recommended information and an information distribution target person to whom the recommended information is distributed.

Further, a decision method performed in a recommended information decision unit (305) of this exemplary embodiment is not limited specifically as far as it is possible to decide a set of recommended information and an information distribution target person to whom the recommended information is distributed using recommended information and target user decision information managed in a recommended information DB (303) shown FIG. 9 and profile information managed in a profile DB (301) shown in FIG. 3, and by applying any methods, a set of recommended information and an information distribution target person can be decided.

For example, in a decision method mentioned above, although an information distribution target person to whom recommended information is delivered is decided using recommended information and target user decision information managed in a recommended information DB (303) and profile information managed in a profile DB (301), it is also possible to configure so that recommended information distributed to an information distribution target person is decided. In this case, first, a recommended information decision unit (305) refers to a profile DB (301) shown in FIG. 3 and acquires profile information on a user who becomes an information distribution target person from a profile DB (301). Next, a recommended information decision unit (305) refers to a recommended information DB (303) shown in FIG. 9, compares profile information acquired from a profile DB (301) and target user decision information managed in a recommended information DB (303), and specifies recommended information of target user decision information which has a relationship with profile information. And a recommended information decision unit (305) decides recommended information which has a relationship with profile information as recommended information to be distributed to the information distribution target person. Further, as a decision method of recommended information which has a relationship with profile information, a decision using similarity measure mentioned above is possible.

Thus, a recommended information decision unit (305) of this exemplary embodiment decides a set of recommended information and an information distribution target person to who recommended information is distributed using recommended information and target user decision information managed in a recommended information DB (303) shown in FIG. 9 and profile information managed in a profile DB (301) shown in FIG. 3. And a recommended information decision unit (305) notifies to an introducer decision unit (306), information of information on an information distribution target person (user ID), recommended information, and target user decision information related to the recommended information (Step S4).

Further, although a recommended information decision unit (305) decides a set of recommended information and an information distribution target person to whom the recommended information is distributed using recommended information and target user decision information managed in a recommended information DB (303) shown in FIG. 9 and profile information managed in a profile DB (301) shown in FIG. 3, a recommended information decision unit (305) can also receive information on a set of information on distribution target person (user ID), recommended information and target user decision information related to the recommended information from a network and notify an introducer decision unit (306) of the information received.

<Introducer Decision Method>

Next, introducer decision method is described.

An introducer decision unit (306), when information on a set of information on an information distribution target person (user ID), recommended information and target user decision information related to the recommended information is received, refers to a relationship DB (302) shown in FIG. 4 based on information on the information distribution target person (user ID) and acquires relationship information on an information distribution target person (Step S5). As a result, an introducer decision unit (306) can grasp a user who has a relationship with an information distribution target person, and a relationship between the user and an information distribution target person (meeting frequency, communication frequency, reference frequency, credit rating).

For example, in case an information distribution target person is “user IDa”, an introducer decision unit (306) can, based on “user IDa”, and by referring to a relationship DB (302) shown in FIG. 4, specify “users IDb-IDe” as users who have a relationship with the information distribution target person “user IDa”. Also it becomes possible to grasp a relationship between “user IDa” and “users IDb-IDe” (meeting frequency, communication frequency, reference frequency, credit rating). Further, according to this exemplary embodiment, as a relationship between “user IDa” and “user IDb”, the following information included in relationship information is grasped.

Frequency user A (user IDa) meets user B (user IDb) directly (meeting frequency).

Frequency user A (user IDa) communicates with user B (user IDb), by telephone calls, mails, messages and so on (communication frequency).

Frequency user A (user IDa) refers to public information of user B (user IDb) (reference frequency).

Degree of evaluation and reliability of user B (user IDb) by user A (user IDa) (credit rating).

Further, in the above-mentioned description, as a user who has a relationship with an information distribution target person “user IDa”, “user IDb” is taken as an example and description is made. However, a user who has a relationship with an information distribution target person is not limited to “user IDb” only, and as shown in FIG. 4, needless to say, a plurality of users such as “users IDc-IDe” have a relationship.

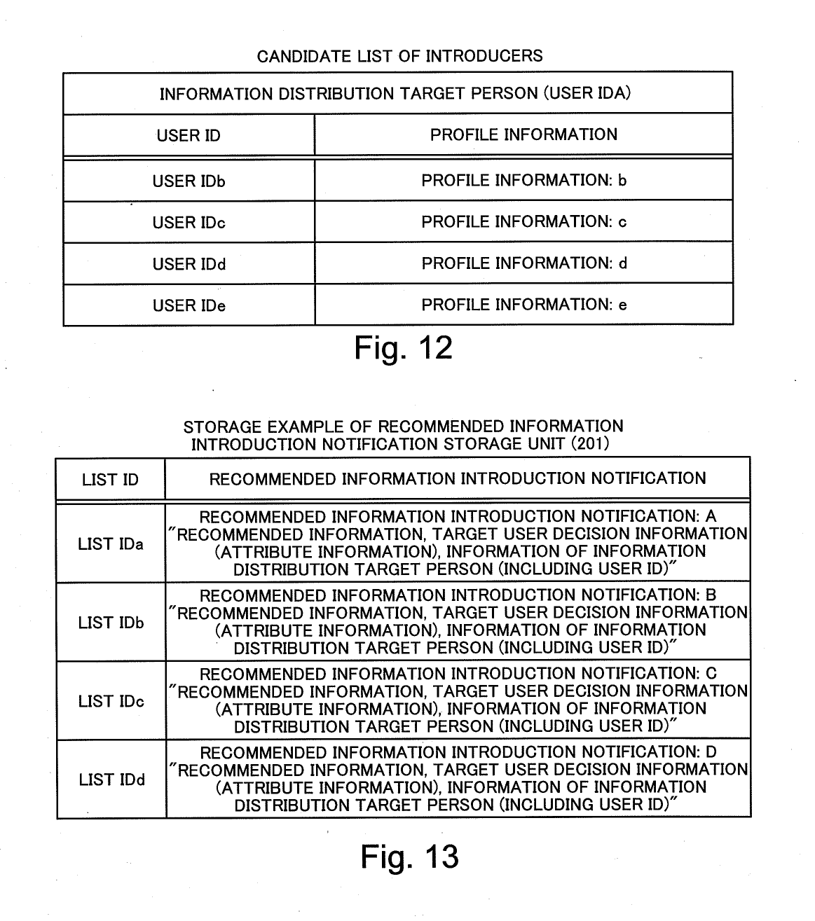

Next, an introducer decision unit (306) refers to a profile DB (301) and acquires profile information on an information distribution target person (user IDa) and profile information on a user (related person: users IDb-IDe) who has a relationship with an information distribution target person (user IDa) (Step S6). As a result, an introducer decision unit (306) can grasp profile information on an information distribution target person (user IDa) and profile information on each user (users IDb-IDe) who has a relationship with an information distribution target person. Further, an introducer decision unit (306) manages a list of profile information on each user (users IDb-IDe) acquired from a profile DB (301) as a candidate list of introducers. Further, as shown in FIG. 12, a candidate list of introducers is created by relating users IDb-IDe of each user who has a relationship with an information distribution target person (user IDa) and profile information.

Next, an introducer decision unit (306) decides an introducer (user ID) to whom information distribution to an information distribution target person (user IDa) is requested based on a candidate list of introducers shown in FIG. 12 (Step S7). Further, as an introducer (user ID) decision method, the following method can be mentioned.

For example, based on attribute information in target user decision information of recommended information, and in case recommended information is information on articles, an article list included in profile information on users (users IDb-IDe) who are in a candidate list of introducers and articles in recommended information are compared. And a user (user ID) who possesses same article as an article in recommended information is decided as an introducer.

Attribute information included in profile information of users (users IDb-IDe) who are in a candidate list of introducers and attribute information in target user decision information are compared, and a user (user ID) with profile information which has attribute information with similarity to attribute information of target user decision information is decided as an introducer.

Based on schedule information included in profile information of users (users IDb-IDe) who are in a candidate list of introducers, a user (user ID) who has an appointment with an information distribution target person (user IDa) is decided as an introducer.

Location information on an information distribution target person (user IDa) and users (users IDb-IDe) who are in a candidate list of introducers is acquired from a presence DB (304), and based on acquired location information on an information distribution target person (user IDa) and location information on users (users IDb-IDe) who are in a candidate list of introducers, a distance between the information distribution target person (user IDa) and the users (users IDb-IDe) who are in a candidate list of introducers is calculated. And a user (user ID) whose calculated distance is closer than the predetermined distance is decided as an introducer. Further, the predetermined distance can be changed arbitrarily. As a result, an introducer decision unit (306) decides a user, who is in a candidate list of introducers, and is located within the range of a predetermined distance from location information on an information distribution target person (user IDa), as an introducer.

By using meeting frequency, communication frequency, reference frequency and credit rating between an information distribution target person (user IDa) and users (users IDb-IDe) who are in a candidate list of introducers (further, meeting frequency, communication frequency, reference frequency and credit rating are information included in relationship information of an information distribution target person (user IDa)), a user (user ID) with the frequency: X higher than a predetermined value is decided as an introducer. Further, as a calculation method of frequency: X, the following (formula 7) can be mentioned.

Frequency: X=(meeting frequency+communication frequency+reference frequency)*credit rating (formula 7)

For example, when frequency: X of user IDb is calculated based on information shown in FIGS. 5-8, following value is obtained.

Frequency of user IDb: X=(meeting frequency: 4/12+communication frequency: (⅚)+( 0/10)+reference frequency: 1/16)*credit rating: 110≈8

Further, as for calculation of frequency: X by the above-mentioned (formula 7), by applying different weight to each of meeting frequency, communication frequency, reference frequency and credit rating, and based on the weighted meeting frequency, communication frequency, reference frequency and credit rating, above-mentioned frequency: X can be calculated. Further, the above-mentioned predetermined value can be changed arbitrarily. Further, the calculation method of frequency: X by the above-mentioned (formula 7) is an example and it is also possible to configure so that frequency: X is calculated by using any calculation methods.

A user (user ID) for whom at least one value among meeting frequency, communication frequency, reference frequency and credit rating between an information distribution target person (user IDa) and users (users IDb-IDe) who are in a candidate list of introducers is higher than a predetermined value, is decided as an introducer. Further, the above-mentioned predetermined value can be changed arbitrarily according to each information (meeting frequency, communication frequency, reference frequency, credit rating).

Based on a service list included in profile information on an information distribution target person (user IDa) and users (user IDb-IDe) who are in a candidate list of introducers, a user (user ID) using the same service as an information distribution target person (user IDa) is decided as an introducer.

By using community information included in profile information on an information distribution target person (user IDa) and users (users IDb-IDe) who are in a candidate list of introducers, a user (user ID) belonging to an identical community with an information distribution target person (user IDa) is decided as an introducer. Further, in this case, by using attribute information on a community and attribute information of target user decision information, when attribute information on a community and attribute information of target user decision information are similar, a user (user ID) belonging to the identical community can be decided as an introducer. Further, as judgment of similarity, a method performed by using similarity measure mentioned above can be mentioned.

By using credit rating between an information distribution target person (user IDa) and users (users IDb-IDe) who are in a candidate list of introducers, (further, credit rating is information included in relationship information on an information distribution target person (user IDa)), a user (user ID) whose credit rating is higher than a predetermined value is decided as an introducer. Further, a predetermined value can be changed arbitrarily.

Attribute information included in profile information on an information distribution target person (user IDa) and attribute information included in profile information on users (users IDb-IDe) who are in a candidate list of introduces are compared, and similarity measures between attribute information of the both are calculated for each user (users IDb-IDe).

For example, suppose there are five of attribute information included in profile information on user (user IDb) who are in a candidate list of introducers, and among five of the attribute information, there are three of attribute information which coincide with attribute information included in profile information on an information distribution target person (user IDa). In this case, a method to calculate as similarity measure=⅗ can be mentioned. Further, a calculation method of similarity measure is not limited specifically and any publicly known calculation methods can be applied.

Next, based on similarity measures calculated for each user (users IDb-IDe) and relationship information on each user (users IDb-IDe) (meeting frequency, communication frequency, reference frequency, credit rating), unified score of each user (users IDb-IDe) is calculated. Further, a calculation of unified score is calculates by the following (formula 8).

Unified score=similarity measure*(meeting frequency+communication frequency+reference frequency)*credit rating (formula 8)

For example, when unified score of user IDb is calculated based on information shown in FIGS. 5-8, the following value is obtained.

Unified score of user IDb=similarity measure: ⅗*(meeting frequency: 4/12+communication frequency: (⅚)+( 0/10)+reference frequency: 1/16)*credit rating: 110≈4.8

Next, based on unified score calculated for each user (users IDb-IDe), an introducer is decided by the following methods.

1: A user (user ID) with the highest unified score is decided as an introducer.

2: In order of the unified score, starting from the highest, predetermined number of people (three highest ranks, for example) are decided as introducers.

3: A user (user ID) with unified score no smaller than the predetermined threshold value is decided as an introducer.

Further, the predetermined number of people and the above-mentioned predetermined threshold value can be changed arbitrarily.

Thus, an introducer decision unit (306), based on a candidate list of introducers shown in FIG. 12, adopts at least one decision method among various decision methods mentioned above and decides an introducer to whom information introduction to an information distribution target person is requested.

Further, when an introducer is decided using the above-mentioned decision method adopted, an introducer decision unit (306) creates recommended information introduction notification based on recommended information, target user decision information and information on an information distribution target person (including user IDa) which are notified from a recommended information decision unit (305). Further, recommended information, target user decision information and information on an information distribution target person (including user IDa) are included in a recommended information introduction notification. And an introducer decision unit (306) notifies a recommended information introduction notification distribution unit (307) of the created recommended information introduction notification and information on introducer (including user ID) (Step S8).

<Distribution Method of Recommended Information Introduction Notification>

Next, a distribution method of a recommended information introduction notification is described.

A recommended information introduction notification distribution unit (307) distributes, when a recommended information introduction notification and information on an introducer (including user ID) are received, a recommended information introduction notification to an introducer terminal (200) which corresponds to the received information (user ID) on an introducer (Step S9). When a recommended information introduction notification is received, an introducer terminal (200) stores the received recommended information introduction notification in a recommended information introduction notification storage unit (201). Further, a recommended information introduction notification storage unit (201) stores a recommended information introduction notification as shown in FIG. 13. FIG. 13 indicates a state when a recommended information introduction notification is stored in a recommended information introduction notification storage unit (201), and recommended information, target user decision information (attribute information) and information on an information distribution target person (including user ID) are included in the recommended information introduction notification.

<Presentation Method of Recommended Information Introduction Notification>

Next, a presentation method of a recommended information introduction notification is described.

A recommended information introduction notification display unit (202) presents a recommended information introduction notification stored in a recommended information introduction notification storage unit (201) to an introducer by the following method (Steps S10 and 11).

When an introducer operates an introducer terminal (200) and refers to a telephone directory DB (205), information (referred user ID) on a user who referred to the telephone directory DB (205) is notified to a recommended information introduction notification display unit (202). A recommended information introduction notification display unit (202) searches a recommended information introduction notification storage unit (201) based on a referred user ID, and judges whether a referred user ID is stored in a recommended information introduction notification storage unit (201).

When a referred user ID is stored in a recommended information introduction notification storage unit (201), a recommended information introduction notification display unit (202) presents to an introducer the effect that a user who referred to a telephone directory DB (205) is an information distribution target person. Also, a recommended information introduction notification display unit (202) presents a recommended information introduction notification related to a user who referred to a telephone directory DB (205) to an introducer.

As a result, when a user who referred to a telephone directory DB (205) corresponds to an information distribution target person, an introducer can grasp the effect that the user is an information distribution target person. Also, an introducer can refer to a recommended information introduction notification related to a user who referred to a telephone directory DB (205).

Further, when an introducer makes a telephone call, writes a mail or the like, as a telephone directory DB (205) is referred, if information (partner user ID) on a partner to whom a telephone call is made or a mail is written is stored in a recommended information introduction notification storage unit (201), an introducer can grasp the effect that a partner to whom a telephone call is made or a mail is written is an information distribution target person. Also an introducer can refer to a recommended information introduction notification related to a partner to whom a telephone call is made or a mail is written.

Also, when an introducer receives a text message, a telephone call, a TV phone call and so on from a communication partner side, a communication unit (206) notifies a recommended information introduction notification display unit (202) of information (partner user ID) on the communication partner. A recommended information introduction notification display unit (202) searches a recommended information introduction notification storage unit (201) based on a partner user ID, and judges whether a partner user ID is stored in a recommended information introduction notification storage unit (201). When a partner user ID is stored in a recommended information introduction notification storage unit (201), a recommended information introduction notification display unit (202) presents to an introducer the effect that a communication partner is an information distribution target person. Also a recommended information introduction notification display unit (202) presents to an introducer a recommended information introduction notification related to a communication partner.

As a result, when a communication partner from whom communication is received corresponds to an information distribution target person, an introducer can grasp the effect that the communication partner is an information distribution target person. Also an introducer can refer to a recommended information introduction notification related to a communication partner. As a result, when communication is received, an introducer can grasp recommended information in which a communication partner from whom the communication is received is likely to have an interest.

Also a recommended information introduction notification display unit (202) registers, based on a recommended information introduction notification stored in a recommended information introduction notification storage unit (201), information on a set of a user ID of an information distribution target person included in the recommended information introduction notification and a user ID of a introducer (introducer terminal: 200) in a presence DB (304). A presence DB (304) calculates a distance between an information distribution target person and an introducer based on presence information (location information) on an information distribution target person and an introducer, and when calculated distance becomes less than the predetermined distance, notifies a recommended information introduction notification display unit (202) of information (user ID) on an information distribution target person. When information (user ID) on an information distribution target person is acquired from a presence DB (304), a recommended information introduction notification display unit (202) searches a recommended information introduction notification storage unit (201) based on information (user ID) on the information distribution target person acquired, and acquires a recommended information introduction notification related to information (user ID) on an information distribution target person. And a recommended information introduction notification display unit (202) presents a recommended information introduction notification acquired from a recommended information introduction notification storage unit (201) to an introducer. As a result, an introducer can grasp an information distribution target person who exists within the range of the predetermined distance from the introducer. Also an introducer can refer to a recommended information introduction notification related to the information distribution target person.

Also based on a recommended information introduction notification stored in a recommended information introduction notification storage unit (201), a recommended information introduction notification display unit (202) registers information on a set of a user ID of an information distribution target person included in the recommended information introduction notification and a user ID of an introducer (200) in a short-distance communication unit (203). When short-distance communication is performed between an information distribution target person and an introducer, a short-distance communication unit (203) notifies a recommended information introduction notification display unit (202) of information (user ID) on the information distribution target person. When information (user ID) on an information distribution target person is acquired from a short-distance communication unit (203), based on information (user ID) on the information distribution target person acquired, a recommended information introduction notification display unit (202) searches a recommended information introduction notification storage unit (201) and acquires a recommended information introduction notification related to information (user ID) on an information distribution target person. And a recommended information introduction notification display unit (202) presents a recommended information introduction notification acquired from a recommended information introduction notification storage unit (201) to an introducer. As a result, when a communication partner with whom short-distance communication is made corresponds to an information distribution target person, an introducer can grasp the effect that the communication partner is an information distribution target person. Also an introducer can refer to a recommended information introduction notification related to a communication partner with whom short-distance communication is made. As a result, an introducer can grasp a recommended information in which a communication partner with whom short-distance communication is made is likely to have an interest.

Also when an introducer performs a data reference using a data reference unit (204), a data reference unit (204) notifies a recommended information introduction notification display unit (202) of referred contents of data. Based on referred contents received from a data reference unit (204), a recommended information introduction notification display unit (202) searches a recommended information introduction notification storage unit (201) and judges whether a recommended information introduction notification related to referred contents exist in a recommended information introduction notification storage unit (201). When a recommended information introduction notification related to referred contents exists in a recommended information introduction notification storage unit (201), a recommended information introduction notification display unit (202) acquires a recommended information introduction notification related to the referred contents from a recommended information introduction notification storage unit (201) and presents the acquired recommended information introduction notification concerned to an introducer. As a result, an introducer can refer to a recommended information introduction notification related to referred contents for which data reference is performed.

Further, as a judgment method for judging as a recommended information introduction notification related to referred contents, a method can be mentioned which compares target user decision information (attribute information) included in a recommended information introduction notification and attribute information on referred contents, and when similarity measure between attribute information of the both is no smaller than the predetermined value, judges as a recommended information introduction notification related to referred contents. Further, as a calculation method of similarity measure between attribute information of the both, various publicly known calculation methods can be applied.

Thus, when at least one processing among a communication processing by a communication unit (206), a reference processing by a telephone directory DB (205), a short-distance communication processing by a short-distance communication unit (206) and a data reference processing by a data reference unit (204) is performed, a recommended information introduction notification display unit (202) refers to a recommended information introduction notification storage unit (201) and acquires a recommended information introduction notification which has a relationship with the processing mentioned above from a recommended information introduction notification storage unit (201). And the acquired recommended information introduction notification is presented to an introducer (200). Also when information (user ID) on an information distribution target person who exists within the predetermined range of a distance with an introducer (200) is received from a presence DB (304), a recommended information introduction notification display unit (202) refers to a recommended information introduction notification storage unit (201), and acquires a recommended information introduction notification in which information (user ID) on an information distribution target person is included from a recommended information introduction notification storage unit (201). And the acquired recommended information introduction notification is presented to an introducer (200).

Further, a recommended information introduction notification display unit (202) of this exemplary embodiment adopts at least one method among methods mentioned above, and after presenting a recommended information introduction notification stored in a recommended information introduction notification storage unit (201) to an introducer (200), and when an introducer (200) operates an introducer terminal (200) and distribution operation of recommended information to an information distribution target person (100) is performed, a recommended information introduction notification display unit (202) notifies a communication unit (206) of recommended information and information (including user ID) on an information distribution target person (100) included in the recommended information introduction notification. Based on information (user ID) on an information distribution target person (100) notified from a recommended information introduction notification display unit (202), a communication unit (206) communicates with an information distribution target person terminal (100) which corresponds to a user ID of the information distribution target person (100) and distributes recommended information to an information distribution target person (100) (Step S12). As a result, an introducer (200) can distribute recommended information included in a recommended information introduction notification to an information distribution target person (100). Further, when an introducer (200) distributes a recommended information introduction notification to an information distribution target person (100) by a mail form, it can also be configured so that contents of a recommended information introduction notification is customized and distributed. However, in this case, considering interpolation or the like, it is desirable to configure such that subjects which can customize contents of a recommended information introduction notification are restricted, and an information distribution device (300) is configured so that security information for preventing interpolation is included in a recommended information introduction notification, for example.

(Effect of an Information Distribution System of this Exemplary Embodiment)

Thus, in an information distribution system of this exemplary embodiment, when information is desired to be distributed to an information distribution target person (100), an information distribution device (300) decides an introducer (200) who has a relationship with an information distribution target person (100). And via the decided introducer (200), information distribution is performed to an information distribution target person (100). Accordingly, an information distribution system of this exemplary embodiment distributes information to an information distribution target person (100) by an effective method and can improve a probability of information being viewed by an information distribution target person (100). As a result, when information such as an advertisement is distributed to an information distribution target person (100), advertising effect of an advertisement can be improved.

Also, as an information distribution system of this exemplary embodiment performs information distribution to an information distribution target person (100) via an introducer (200), communication between an introducer (200) and an information distribution target person (100) can be activated.

Further, according to the above-mentioned exemplary embodiment, as shown in FIG. 13, an information distribution device (300) includes target user decision information (attribute information) itself in a recommended information introduction notification. However, it can also be configured so that not target user decision information (attribute information) itself, but only attribute information which coincides with attribute information included in profile information of an introducer (200) is included out of target user decision information (attribute information). As a result; only when a data reference related to attribute information included in profile information of an introducer (200) himself is performed, an introducer terminal (200) can present a recommended information introduction notification related to the data reference contents to an introducer (200).

### The Second Exemplary Embodiment

Next, the second exemplary embodiment is described.

According to the first exemplary embodiment, an information distribution device (300) distributes a recommended information introduction notification to an introducer terminal (200) corresponding to a information (user ID) on the introducer (200) automatically based on information (user ID) of an introducer (200).

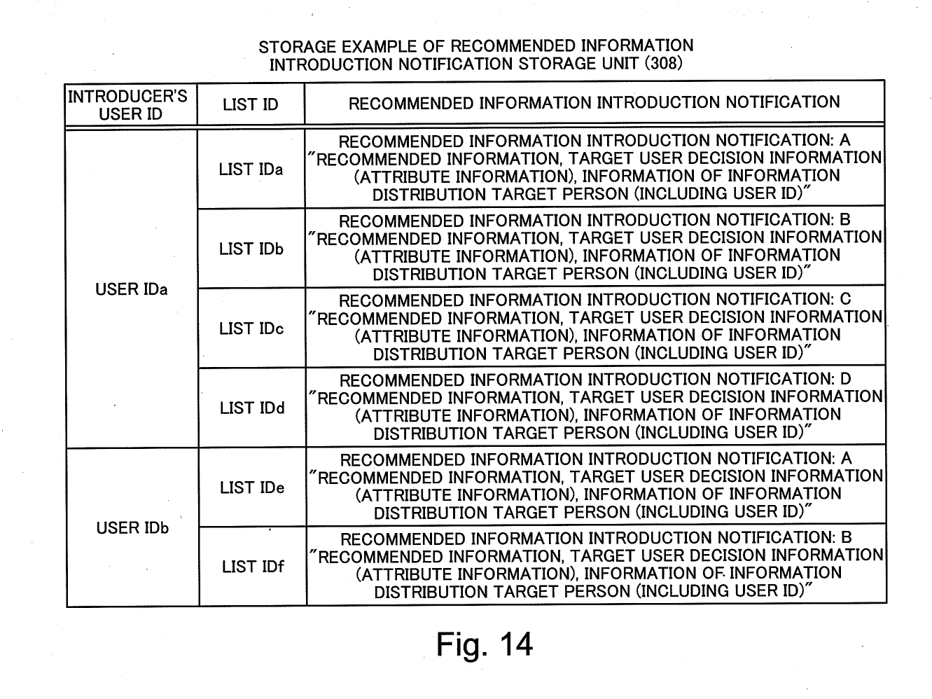

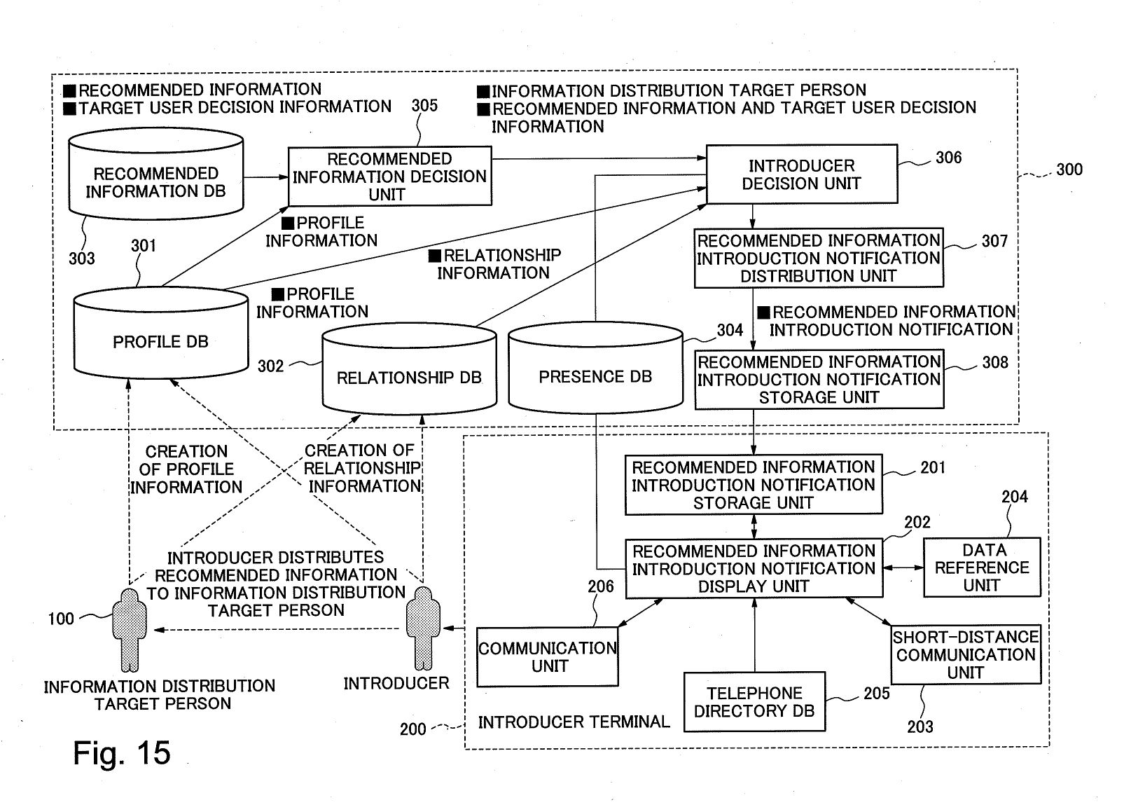

According to the second exemplary embodiment, as shown in FIG. 14, an information distribution device (300) manages a recommended information introduction notification for each information (user ID) on an introducer (200), and when accessed from an introducer (200), an information distribution device (300) is characterized by presenting a recommended information introduction notification corresponding to a user ID of the introducer (200) to an introducer (200). Accordingly, when an introducer (200) accesses an information distribution device (300), an information distribution device (300) can present a recommended information introduction notification to an introducer (200). As a result, a recommended information introduction notification can be presented to an introducer (200) efficiently. Hereinafter, an information distribution system of the second exemplary embodiment is described with reference to FIG. 14 and FIG. 15.

In an information distribution system of the second exemplary embodiment, as shown in FIG. 15, an information distribution device (300) is configured as to include a recommended information introduction notification storage unit (308). Further, as shown in FIG. 14, a recommended information introduction notification storage unit (308) manages a recommended information introduction notification for each user ID of an introducer (200). Further, contents of a recommended information introduction notification can be configured same as the first exemplary embodiment. And when an introducer (200) accesses an information distribution device (300), an information distribution device (300) judges whether a recommended information introduction notification which corresponds to a user ID of the introducer (200) exists in a recommended information introduction notification storage unit (308) or not, and when a recommended information introduction notification which corresponds to a user ID of an introducer (200) exists, acquires a recommended information introduction notification which corresponds to a user ID of the introducer (200) from a recommended information introduction notification storage unit (308). And notifies the acquired recommended information introduction notification to an introducer (200). An introducer (200) stores and manages a recommended information introduction notification notified by an information distribution device (300) in a recommended information introduction notification storage unit (201). Accordingly, when an introducer (200) accesses an information distribution device (300), an information distribution device (300) can present a recommended information introduction notification which corresponds to the introducer (200) to an introducer (200). As a result, a recommended information introduction notification can be presented to an introducer (200) efficiently.

Further, as shown in FIG. 14, an information distribution device (300) of this exemplary embodiment stores and manages a recommended information introduction notification by associating with a list ID for specifying a recommended information introduction notification, in a recommended information introduction notification storage unit (308). For this reason, an introducer (200) of this exemplary embodiment can, instead of distributing recommended information itself to an information distribution target person (100) as in the first exemplary embodiment, also distribute a list ID to an information distribution target person (100). In this case, an information distribution target person (100) accesses an information distribution device (300) based on the list ID and refers to a recommended information introduction notification correlated to the list ID. Further, an introducer (200) can distribute a list ID and recommended information to an information distribution target person (100).

### The Third Exemplary Embodiment

Next, the third exemplary embodiment is described.

According to the first and second exemplary embodiments, an introducer terminal (200) itself manages a recommended information introduction notification, and based on the recommended information introduction notification, distributes at least one information of recommended information and a list ID to an information distribution target person (100).

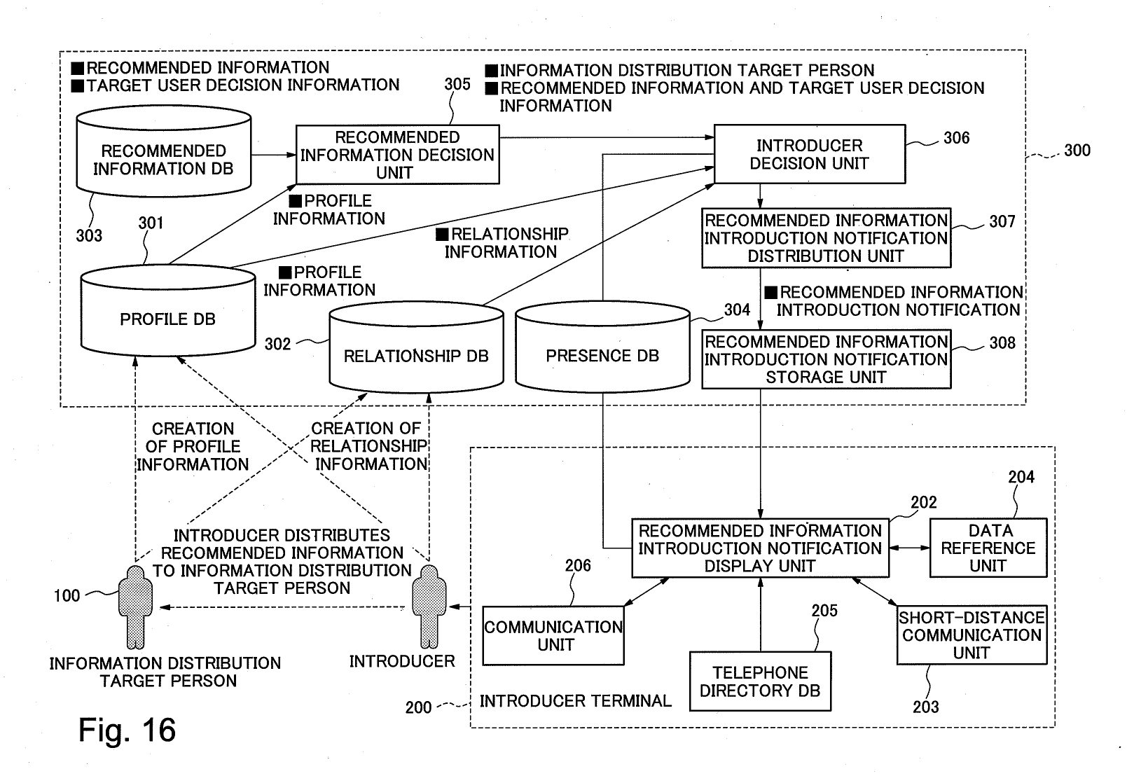

According to the third exemplary embodiment, as shown in FIG. 14, an information distribution device (300) manages a recommended information introduction notification for each information (user ID) on an introducer (200). And based on a recommended information introduction notification managed by an information distribution device (300), an introducer (200) distributes at least one information of recommended information and a list ID to an information distribution target person (100). As a result, even if a recommended information introduction notification is not managed by an introducer terminal (200) itself as shown in an exemplary embodiment mentioned above, an introducer (200) can distribute at least one information of recommended information and a list ID to an information distribution target person (100). Hereinafter, an information distribution system of this exemplary embodiment is described in detail with reference to FIG. 14 and FIG. 16.

In an information distribution system of the third exemplary embodiment, as shown in FIG. 16, an information distribution device (300) is configured as to include a recommended information introduction notification storage unit (308). Further, as shown in FIG. 14, a recommended information introduction notification storage unit (308) manages a recommended information introduction notification for each user ID of an introducer (200).

Also an introducer terminal (200) of this exemplary embodiment is, different from the first and second exemplary embodiments mentioned above, configured without a recommended information introduction notification storage unit (201).

<Presentation Method of Recommended Information Introduction Notification>

Next, a presentation method of a recommended information introduction notification of this exemplary embodiment is described.

When a recommended information introduction notification and information (including user ID) on an introducer are received, as shown in FIG. 14, a recommended information introduction notification distribution unit (307) stores and manages a recommended information introduction notification for each user ID of an introducer, in a recommended information introduction notification storage unit (308). As a result, an information distribution device (300) manages a recommended information introduction notification for each user ID of an introducer.

Further, a recommended information introduction notification display unit (202) of this exemplary embodiment presents a recommended information introduction notification stored in a recommended information introduction notification storage unit (308) to an introducer (200) by the following method.

When an introducer (200) operates an introducer terminal (200) and refers to a telephone directory DB (205), information (referred user ID) on a user who referred to a telephone directory DB (205) is presented to a recommended information introduction notification display unit (202). Based on a referred user ID and a user ID of an introducer (200), a recommended information introduction notification display unit (202) searches a recommended information introduction notification storage unit (308) and judges whether a recommended information introduction notification related to a user ID of an introducer (200) exists or not in a recommended information introduction notification storage unit (308). When a recommended information introduction notification related to a user ID of an introducer (200) exists, a recommended information introduction notification display unit (202) judges whether a recommended information introduction notification in which a referred user ID is included exists or not. When a recommended information introduction notification in which a referred user ID is included exists, a recommended information introduction notification display unit (202) acquires a recommended information introduction notification in which the referred user ID is included from a recommended information introduction notification storage unit (308) and presents the acquired recommended information introduction notification concerned to an introducer (200).

As a result, when a user who referred to a telephone directory DB (205) corresponds to an information distribution target person, an introducer (200) can grasp the effect that the user is an information distribution target person. Also an introducer (200) can refer to a recommended information introduction notification related to a user who referred to a telephone directory DB (205).

Further, when an introducer (200) makes a telephone call, creates a mail or the like, as a telephone directory DB (205) is referred, when information (partner user ID) on a partner to whom a telephone call is made or a mail is created is stored in a recommended information introduction notification storage unit (308), an introducer (200) can grasp the effect that a partner to whom a telephone call is made or a mail is created is an information distribution target person. Also an introducer (200) can refer to a recommended information introduction notification related to a partner to whom a telephone call is made or a mail is created.

Also when an introducer (200) receives a text message, telephone call, a TV phone call and so on from a communication partner side, a communication unit (206) notifies a recommended information introduction notification display unit (202) of information (partner user ID) on a communication partner. A recommended information introduction notification display unit (202) searches a recommended information introduction notification storage unit (308) based on a partner user ID which is notified from a communication unit (206) and a user ID of an introducer (200), and judges whether a recommended information introduction notification related to a user ID of an introducer (200) exists or not in a recommended information introduction notification storage unit (308). When a recommended information introduction notification related to a user ID of an introducer (200) exists, a recommended information introduction notification display unit (202) judges whether a recommended information introduction notification in which a partner user ID is included exists or not. When a recommended information introduction notification in which a partner user ID is included exists, a recommended information introduction notification display unit (202) acquires a recommended information introduction notification in which the partner user ID is included from a recommended information introduction notification storage unit (308) and presents the acquired recommended information introduction notification concerned to an introducer (200).

As a result, when a communication partner from whom communication is received corresponds to an information distribution target person, an introducer (200) can grasp the effect that the communication partner is an information distribution target person. Also an introducer (200) can refer to a recommended information introduction notification related to a communication partner from whom communication is received. As a result, when communication is received, an introducer (200) can grasp recommended information in which a communication partner from whom the communication is received is likely to have an interest.

Also an information distribution device (300) registers information on a set of a user ID of an introducer (200) stored in a recommended information introduction notification storage unit (308) and a user ID of an information distribution target person which is included in a recommended information introduction notification managed by correlating to a user ID of the introducer (200), in a presence DB (304). Based on presence information (location information) on an information distribution target person and an introducer, a presence DB (304) calculates a distance between an information distribution target person and an introducer, and when calculated distance becomes closer than the predetermined distance, based on a user ID of an introducer (200) and a user ID of an information distribution target person, searches a recommended information introduction notification storage unit (308) and acquires a recommended information introduction notification related to a user ID of an introducer (200) and a user ID of an information distribution target person. And a presence DB (304) notifies a recommended information introduction notification display unit (202) of a recommended information introduction notification acquired from a recommended information introduction notification storage unit (308), and a recommended information introduction notification display unit (202) presents a recommended information introduction notification notified from a presence DB (304) to an introducer (200). As a result, an introducer (200) can grasp an information distribution target person who exists within the range of the predetermined distance from the introducer (200). Also an introducer (200) can refer to a recommended information introduction notification related to the information distribution target person.

Also when short-distance communication is performed, a short-distance communication unit (203) notifies a recommended information introduction notification display unit (202) of information (partner user ID) on the communication partner. Based on a partner user ID notified from a short-distance communication unit (203) and a user ID of an introducer (200), a recommended information introduction notification display unit (202) searches a recommended information introduction notification storage unit (308) and judges whether a recommended information introduction notification related to a user ID of an introducer (200) exists or not in a recommended information introduction notification storage unit (308). When a recommended information introduction notification related to a user ID of an in introducer (200) exists, a recommended information introduction notification display unit (202) judges whether a recommended information introduction notification in which a partner user ID is included exists or not. When a recommended information introduction notification in which a partner user ID is included exists, a recommended information introduction notification display unit (202) acquires a recommended information introduction notification in which the partner user ID is included from a recommended information introduction notification storage unit (308) and presents the acquired recommended information introduction notification concerned to an introducer (200). As a result, when a communication partner with whom short-distance communication is made corresponds to an information distribution target person, an introducer (200) can grasp the effect that the communication partner is an information distribution target person. Also an introducer (200) can refer to a recommended information introduction notification related to a communication partner with whom short-distance communication is made. As a result, an introducer (200) can grasp recommended information in which a communication partner with whom short-distance communication is made is likely to have an interest.

Also when an introducer (200) performs data reference using a data reference unit (204), a data reference unit (204) notifies a recommended information introduction notification display unit (202) of referred contents of data. Based on a user ID of an introducer (200) and referred contents received from a data reference unit (204), a recommended information introduction notification display unit (202) searches a recommended information introduction notification storage unit (308) and judges whether a recommended information introduction notification related to a user ID of an introducer (200) and referred contents exists or not in a recommended information introduction notification storage unit (308). When a recommended information introduction notification related to a user ID of an introducer (200) and referred contents exists in a recommended information introduction notification storage unit (308), a recommended information introduction notification display unit (202) acquires a recommended information introduction notification related to a user ID of the introducer (200) and referred contents from a recommended information introduction notification storage unit (308) and presents the acquired recommended information introduction notification concerned to an introducer (200). As a result, an introducer (200) can refer to a recommended information introduction notification related to referred contents for which data reference is performed.

Thus, even if an introducer terminal (200) itself does not manage a recommended information introduction notification, an introducer terminal (200) of this exemplary embodiment can present a recommended information introduction notification to an introducer (200) based on a recommended information introduction notification which is managed by a recommended information introduction notification storage unit (308) of an information distribution device (300).

Further, after a recommended information introduction notification managed by a recommended information introduction notification storage unit (308) is presented to an introducer (200), and when distribution operation of recommended information to an information distribution target person (100) is performed, an introducer terminal (200) communicates with an information distribution target person terminal (100) which corresponds to information (user ID) on the information distribution target person (100) and distributes recommended information to an information distribution target person (100). Also, because an information distribution device (300) of this exemplary embodiment stores and manages a recommended information introduction notification in a recommended information introduction notification storage unit (308) associating with a list ID same as in the second exemplary embodiment, an introducer terminal (200) can distribute a list ID for specifying recommended information to an information distribution target person (100). In this case, an information distribution target person (100) accesses an information distribution device (300) based on the list ID and refers to a recommended information introduction notification correlated to the list ID.

### The Fourth Exemplary Embodiment

Next, the fourth exemplary embodiment is described.

In the first to third exemplary embodiments mentioned above, an introducer (200) distributes at least one information (distribution information) of recommended information and a list ID to an information distribution target person terminal (100) of an information distribution target person (100) directly using an introducer terminal (200).

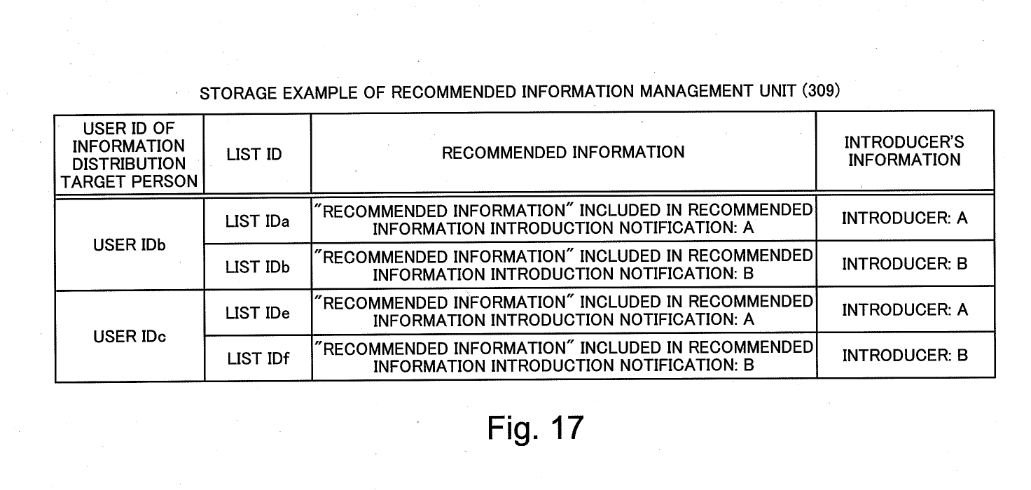

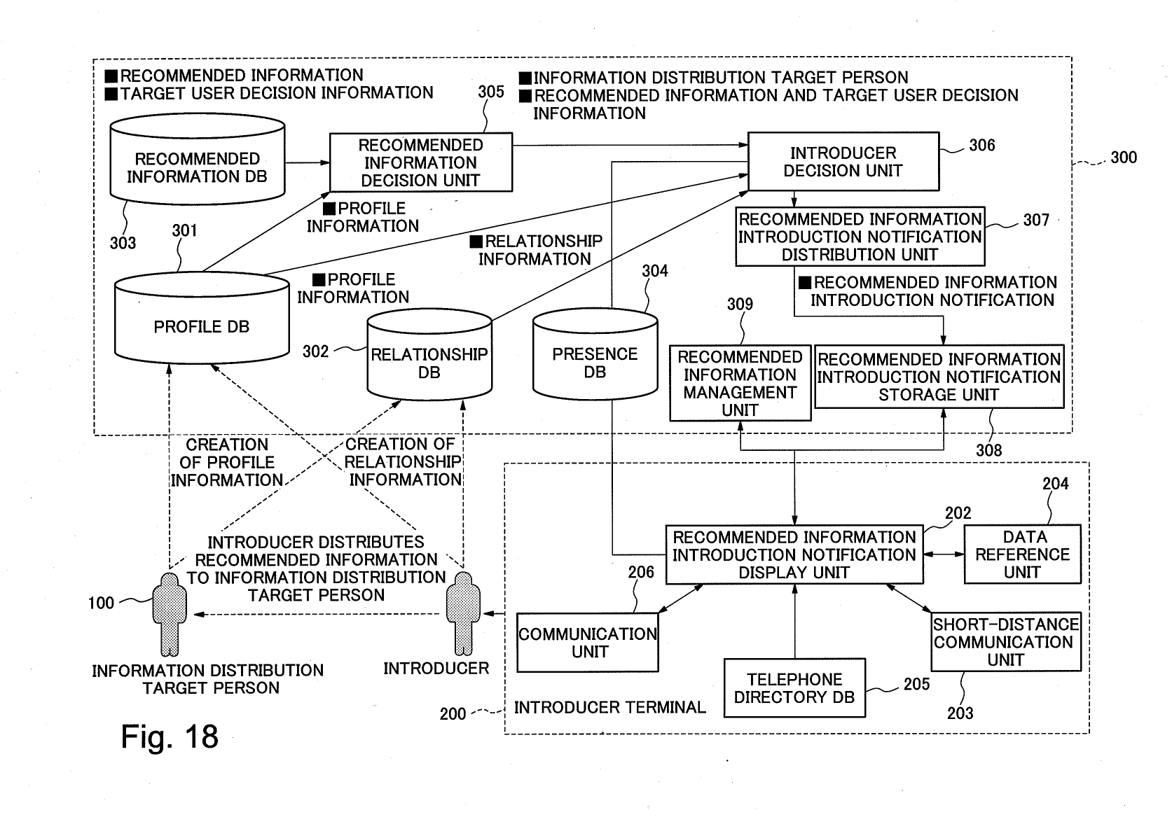

The fourth exemplary embodiment is characterized such that an introducer (200) registers distribution information (recommended information, list ID) in an information distribution device (300) for each user ID of an information distribution target person using an introducer terminal (200) as shown in FIG. 17, and an information distribution target person (100) accesses an information distribution device (300) using an information distribution target person (100) and acquires distribution information corresponding to a user ID of an information distribution target person (100) from an information distribution device (300). As a result, even if distribution information is not distributed directly to an information distribution target person (100), by registering distribution information in an information distribution device (300), an introducer (200) can distribute distribution information registered in the information distribution device (300) to an information distribution target person (100) indirectly. Hereinafter, an information distribution system of this exemplary embodiment is described in detail with reference to FIG. 17 and FIG. 18.

In an information distribution system of the fourth exemplary embodiment, as shown in FIG. 18, an information distribution device (300) is configured as to include a recommended information introduction notification storage unit (308) and a recommended information management unit (309). Further, as shown in FIG. 14, a recommended information introduction notification storage unit (308) manages a recommended information introduction notification for each user ID of an introducer (200). Also as shown in FIG. 17, a recommended information management unit (309) manages distribution information (recommended information, list ID) for each user ID of an information distribution target person (100). Further, in FIG. 17, a state is indicated in which distribution information is managed such that distribution information is related to information on an introducer (200) registered in a recommended information management unit (309).

Also, an introducer terminal (200) of this exemplary embodiment is, same as in the third exemplary embodiment mentioned above, configured without a recommended information introduction notification storage unit (201).

<Distribution Method of Recommended Information to Information Distribution Target Person: 100>

Next, a distribution method of recommended information to an information distribution target person (100) is described.

When a recommended information introduction notification and information (including user ID) on an introducer are received, as shown in FIG. 14, a recommended information introduction notification distribution unit (307) stores and manages a recommended information introduction notification in a recommended information introduction notification storage unit (308) for each user ID of an introducer. As a result, an information distribution device (300) manages a recommended information introduction notification for each user ID of an introducer.

Further, a recommended information introduction notification display unit (202) of this exemplary embodiment presents a recommended information introduction notification stored in a recommended information introduction notification storage unit (308) to an introducer (200) by the same method as in the third exemplary embodiment. When a recommended information introduction notification presented by a recommended information introduction notification display unit (202) is distributed to an information distribution target person (100), as shown in FIG. 17, an introducer (200) registers in a recommended information management unit (309) recommended information included in the recommended information introduction notification, a list ID for specifying the recommended information introduction notification and information on an introducer (200) by correlating to a user ID of an information distribution target person (100). As a result, an information distribution device (300) can manage distribution information (recommended information, list ID) and information on an introducer (200) for each user ID of an information distribution target person (100). Further, in FIG. 17, although a state in which distribution information (list ID, recommended information) is registered by correlating to a user ID of an information distribution target person (100) is shown, at least one of a list ID and recommended information is enough to be registered.

Next, when accessed from an information distribution target person (100), an information distribution device (300) judges whether recommended information corresponding to a user ID of the information distribution target person (100) or a list ID is stored in a recommended information management unit (309) or not. When recommended information corresponding to a user ID of an information distribution target person (100) or a list ID is stored in a recommended information management unit (309), an information distribution device (300) acquires recommended information corresponding to a user ID of the information distribution target person (100), a list ID and information on an introducer (200) from a recommended information management unit (309), and presents the acquired recommended information, a list ID and information on an introducer (200) to an information distribution target person (100). As a result, an information distribution target person (100) acquires recommended information and a list ID which a person who is an introducer (200) having a relationship with an information distribution target person (100) has registered in a recommended information management unit (309). Further, when a list ID is acquired, an information distribution target person (100) accesses an information distribution device (300), and acquires recommended information related to the list ID from a recommended information introduction notification storage unit (308) of an information distribution device (300).

As a result, even if distribution information (recommended information, list ID) is not distributed directly to an information distribution target person (100), by registering distribution information in an information distribution device (300), an introducer (200) can distribute distribution information registered in the information distribution device (300) to an information distribution target person (100) indirectly. Also by registering information on an introducer (200) together with distribution information in an information distribution device (300), an introducer (200) can present distribution information registered in the information distribution device (300) to an information distribution target person (100) along with information on an introducer (200).

Further, an exemplary embodiment mentioned above is a preferred exemplary embodiment of the present invention, the scope of the present invention is not limited to only the above-mentioned exemplary embodiment, and to the extent that does not deviate from the scope of the present invention, it is possible that a person skilled in the art performs corrections or substitutions of the above-mentioned exemplary embodiment and configures the embodiment to which various changes are applied.

For example, in an information distribution system of this exemplary embodiment mentioned above, although distribution information (recommended information, list ID) is distributed to an information distribution target person (100) via an introducer (200) as human, it can also be configured such that not an introducer (200) as human stands in between, but distribution information is distributed to an information distribution target person (100) via an introducer as a machine.

Also in an information distribution system mentioned above, when an introducer (200) distributes distribution information to an information distribution target person (100), it can also be configured so that a reward according to distribution of the distribution information is given to an introducer (200).

Also a control operation in each device which constitutes an information distribution system of this exemplary embodiment mentioned above can be executed using hardware, software, or a compound structure of both of them.

Further, when a processing is executed using software, it is possible to install a program in which processing sequence is recorded in a memory in a computer included in special purpose hardware and execute it. Or, it is possible to install a program on a general-purpose computer which can execute various processing and execute it.

For example, a program can be recorded in advance in a hard disk or ROM (Read Only Memory) as a recording media. Or, a program can be stored (recorded) in a removable recording media temporarily or permanently. Such a removable recording media can be provided as so-called software package. Further, as a removable recording media, a floppy (registered trademark) disk, a CD-ROM (Compact Disc Read Only Memory), an MO (Magneto optical) disk, a DVD (Digital Versatile Disc), a magnetic disk, a semiconductor memory and so on can be mentioned.

Further, a program is installed in a computer from the removable recording media mentioned above. Or from a download site, it is transmitted to a computer using wireless transmission. Or it is transmitted to a computer via a network using wired transmission.

Also an information distribution system of this exemplary embodiment, not only executes a processing chronologically according to a processing operation described in the above-mentioned exemplary embodiment, depending on a processing capability of a device on which a processing is executed or on necessity, can also be configured to execute a processing in parallel or individually.

Also, an information distribution system of this exemplary embodiment can be configured as a logical set structure of a plurality of devices, or as a structure where devices of each structure exist in an identical cabinet.

Further, this application claims priority based on Japanese application Japanese Patent Application No. 2008-030504 filed on Feb. 12, 2008 and the disclosure thereof is incorporated herein in its entirety.

Industrial Availability

The present invention is applicable to a distribution service or the like which distributes various information to a user.

### BRIEF DESCRIPTION OF THE DRAWINGS [FIG. 1] A figure showing an example of a system configuration of an information distribution system of this exemplary embodiment.

[FIG. 2] A figure showing an example of an internal configuration of an information distribution device (300) and an introducer terminal (200) which an information distribution system includes.

[FIG. 3] A figure showing an example of a data configuration of a profile DB (301).

[FIG. 4] A figure showing an example of a data configuration of a relationship DB (302).

[FIG. 5] A figure illustrating meeting frequency.

[FIG. 6] A figure illustrating communication frequency.

[FIG. 7] A figure illustrating reference frequency.

[FIG. 8] A figure illustrating credit rating.

[FIG. 9] A figure showing an example of a data configuration of a recommended information DB (303).

[FIG. 10] A figure showing an example of a data configuration of a presence DB (304).

[FIG. 11] A figure showing an example of series of processing operations in an information distribution system of this exemplary embodiment.

[FIG. 12] A figure showing an example of a configuration of a candidate list of introducers.

[FIG. 13] A figure showing an example of a data configuration of a recommended information introduction notification storage unit (201).

[FIG. 14] A figure showing an example of a data configuration of a recommended information introduction notification storage unit (308).

[FIG. 15] A figure showing an example of a configuration of an information distribution system of the second exemplary embodiment.

[FIG. 16] A figure showing an example of a configuration of an information distribution system of the third exemplary embodiment.

[FIG. 17] A figure showing an example of a data configuration of a recommended information management unit (309).

[FIG. 18] A figure showing an example of a configuration of an information distribution system of the fourth exemplary embodiment.

### DESCRIPTION OF CODE

100 Information distribution target terminal

200 Introducer terminal

300 Information distribution device

NW Network.

201 Recommended information introduction notification storage unit

202 Recommended information introduction notification display unit

203 Short-distance communication unit

204 Data reference unit

205 Telephone directory DB (Data Base)

206 Communication unit

301 Profile DB

302 Relationship DB

303 Recommended information DB

304 Presence DB

305 Recommended information decision unit

306 Introducer decision unit

307 Recommended information introduction notification distribution unit

308 Recommended information introduction notification storage unit

309 Recommended information management unit

1-28. (canceled)

29. An information distribution device comprising:
a decision unit which decides an introducer who distributes information to a terminal of an information distribution target person; and
a distribution unit which requests an information distribution to a terminal of said information distribution target person, to a terminal of an introducer who is decided by said decision unit; wherein
said decision unit
decides a related person who has a relationship with said information distribution target person as an introducer.

30. The information distribution device of claim 29 comprising:
a relationship management unit which manages relationship information for specifying said related person for each said information distribution target person, wherein
said decision unit
acquires relationship information which corresponds to said information distribution target person from said relationship management unit, specifies said related person based on the acquired relationship information concerned, and decides the specified related person concerned as said introducer.

31. The information distribution device of claim 30 comprising:
a profile management unit which manages profile information, wherein
said decision unit,
in case information distributed to a terminal of said information distribution target person is information on an article,
acquires profile information of said related person from said profile management unit, and based on an article list included in the acquired profile information of a related person concerned, decides a related person who possesses an article identical with an article of said information as said introducer.

32. The information distribution device of claim 2 comprising:
a profile management unit which manages profile information, wherein
said decision unit
acquires profile information of said related person from said profile management unit, and based on attribute information included in the acquired profile information of a related person concerned, decides a related person with profile information having attribute information with similarity to attribute information of information distributed to a terminal of said information distribution target person as said introducer.

33. The information distribution device of claim 30 comprising:
a profile management unit which manages profile information, wherein
said decision unit
acquires profile information of said related person from said profile management unit, and based on schedule information included in the acquired profile information of a related person concerned, decides a related person who has an appointment with said information distribution target person as said introducer.

34. The information distribution device of claim 30 comprising:
a profile management unit which manages profile information, wherein
said decision unit
acquires profile information on said information distribution target person and said related person from said profile management unit, and based on a service list included in the acquired profile information concerned, decides a related person using an identical service with said information distribution target person as said introducer.

35. The information distribution device of claim 30 comprising:
a profile management unit which manages profile information, wherein
said decision unit
acquires profile information on said information distribution target person and said related person from said profile management unit, and based on community information included in the acquired profile information concerned, decides a related person belonging to an identical community with said information distribution target person as said introducer.

36. The information distribution device of claim 30 comprising:
a presence management unit which manages location information, wherein
said decision unit
acquires location information on said information distribution target person and said related person from said presence management unit, and based on the acquired location information concerned, decides a related person located within a range of a predetermined distance from location information on said information distribution target person as said introducer.

37. The information distribution device of claim 30, wherein said relationship information is characterized by
being configured as to comprise a related person who has a relationship with said information distribution target person, and
said decision unit
is characterized by, based on a related person included in relationship information which corresponds to said information distribution target person, specifying said related person.

38. The information distribution device of claim 30, wherein said relationship information is characterized by being configured as to comprise at least one information of:
meeting frequency that said information distribution target person meets with said related person directly,
communication frequency that said information distribution target person communicates with said related person,
reference frequency that said information distribution target person refers to public information of said related person, and
credit rating indicating a degree how much said information distribution target person trusts said related person; and
said decision unit
is characterized by, based on at least one information of said meeting frequency, said communication frequency, said reference frequency and said credit rating, deciding said introducer from among said related person.

39. The information distribution device of claim 38, wherein said decision unit is
characterized by calculating a score value according to said meeting frequency, said communication frequency, said reference frequency and said credit rating for each said related person, and based on the calculated score value concerned, deciding said introducer.

40. The information distribution device of claim 38, wherein said score value is characterized by being calculated using the following formula;
score value=(meeting frequency+communication frequency+reference frequency)*credit rating formula

41. The information distribution device of claim 29, wherein said distribution unit is
characterized by distributing introduction notification including information on said information distribution target person and distribution information distributed to the information distribution target person concerned, to a terminal of said introducer, and
requesting to said introducer to distribute said distribution information to a terminal of said information distribution target person.

42. The information distribution device of claim 29 comprising:
a introduction notification storage unit which relates an introduction notification including information on said information distribution target person and distribution information distributed to the information distribution target person concerned to a list ID for specifying said introduction notification, and stores it; wherein
said distribution unit
distributes information on said information distribution target person and said list ID to a terminal of said introducer, and
requests to said introducer to distribute said list ID to a terminal of said information distribution target person.

43. The information distribution device of claim 41 comprising:
an introduction notification management unit which, by a registration request from said introducer, and together with information on the introducer concerned, manages said distribution information distributed to a terminal of said introducer by said distribution unit, for each information on said information distribution target person; and
a presentation unit which presents said distribution information managed for each information on said information distribution target person by said introduction notification management unit, to a terminal of said information distribution target person together with information on said introducer.

44. The information distribution device of claim 42 comprising:
unit which, by a registration request from said introducer, and together with information on the introducer concerned, manages said list ID distributed to a terminal of said introducer by said distribution unit, for each information on said information distribution target person; and
a presentation unit which presents said list ID managed for each information on said information distribution target person by said introduction notification management unit, to a terminal of said information distribution target person together with information on said introducer.

45. A terminal of an introducer which distributes information to an information distribution target person, comprising:
an introduction notification display unit which displays an introduction notification including information on said information distribution target person and distribution information distributed to the information distribution target person concerned; and
a distribution unit which, after displaying said introduction notification by said introduction notification display unit, and in case distribution operation of said introduction notification is performed, distributes at least one information of said distribution information and a list ID for specifying said introduction notification, to a terminal of an information distribution target person included in said introduction notification.

46. A terminal of an introducer which distributes information to an information distribution target person, comprising:
an introduction notification display unit which displays an introduction notification including information on said information distribution target person and distribution information distributed to the information distribution target person concerned; and
a registration unit which, after displaying said introduction notification by said introduction notification display unit, and in case distribution operation of said introduction notification is performed, correlates at least one information of said distribution information and a list ID for specifying said introduction notification to information on said information distribution target person, and registers it to an introduction information management unit.

47. The terminal of claim 45, wherein said introduction notification display unit is
characterized by, in case at least one of a communication processing, a reference processing of a telephone directory DB, a short-distance communication processing, or a data reference processing is performed, referring to an introduction notification storage unit which stores said introduction notification, acquiring said introduction notification which has a relationship with said processing from said introduction notification storage unit, and displaying the acquired introduction notification concerned.

48. The terminal of claim 47, wherein, said introduction notification display unit is
characterized by, in case a communication processing, a reference processing of a telephone directory DB or a short-distance communication processing is performed, referring to said introduction notification storage unit, acquiring said introduction notification in which an information distribution target person who has a relationship with said processing is included from said introduction notification storage unit, and displaying the acquired introduction notification concerned.

49. The terminal of claim 47, wherein said introduction notification is characterized by including attribute information for specifying said distribution information, and
said introduction notification display unit is
characterized by, in case a data reference processing is performed, referring to said introduction notification storage unit, acquiring said introduction notification in which attribute information which has a relationship with data reference contents is included from said introduction notification storage unit, and displaying the acquired introduction notification concerned.

50. The terminal of claim 45, wherein said introduction notification display unit is
characterized by, in case information on said information distribution target person who exists within a predetermined range of distance from said introducer is received, referring to said introduction notification storage unit, acquiring said introduction notification in which information on said information distribution target person is included from said introduction notification storage unit, and displaying the acquired introduction notification concerned.

51. An information distribution system comprising:
a terminal and an information distribution device, wherein
said information distribution device comprises
a decision unit which decides an introducer who distributes information to a terminal of an information distribution target person; and
a distribution unit which requests an information distribution to a terminal of said information distribution target person, to a terminal of an introducer decided by said decision unit; wherein
said decision unit
decides a related person who has a relationship with said information distribution target person as an introducer.

52. An information distribution method comprising:
deciding an introducer who distributes information to a terminal of an information distribution target person; and
requesting information distribution to a terminal of said information distribution target person, to a terminal of said introducer, and
deciding a related person who has a relationship with said information distribution target person as an introducer.

53. A computer readable non-transitory medium for storing an information distribution program which makes a computer execute:
a decision processing in which decides an introducer who distributes information to a terminal of an information distribution target person; and
a distribution processing in which requests an information distribution to a terminal of said information distribution target person, to a terminal of an introducer decided by said decision processing; wherein
said decision processing in which
decides a related person who has a relationship with said information distribution target person as an introducer.

54. A method comprising:
displaying an introduction notification including information on an information distribution target person and distribution information distributed to the information distribution target person concerned on a display unit; and
distributing, at least one information of said distribution information and a list ID for specifying said introduction notification to a terminal of an information distribution target person included in said introduction notification after displaying said introduction notification on said display unit, and in case distribution operation of said introduction notification is performed.

55. A method comprising:
displaying an introduction notification including information on an information distribution target person and distribution information distributed to the information distribution target person concerned on a display unit; and
correlating at least one information of said distribution information and a list ID for specifying said introduction notification to information on said information distribution target person, and registering it to an introduction information management unit after displaying said introduction notification on said display unit, and in case distribution operation of said introduction notification is performed.

56. A computer readable non-transitory medium for storing an information distribution program which makes a computer execute:
an introduction notification display processing in which displays an introduction notification including information on an information distribution target person and distribution information distributed to the information distribution target person concerned on a display unit; and
a distribution processing in which, after displaying said introduction notification on said display unit by said introduction notification display processing, and in case distribution operation of said introduction notification is performed, distributes at least one information of said distribution information and a list ID for specifying said introduction notification to a terminal of an information distribution target person included in said introduction notification.

57. A computer readable non-transitory medium for storing an information distribution program which makes a computer execute:
an introduction notification display processing in which displays an introduction notification including information on an information distribution target person and distribution information distributed to the information distribution target person concerned on a display unit; and
a registration processing in which, after displaying said introduction notification on said display unit by said introduction notification display processing, and in case distribution operation of said introduction notification is performed, correlates at least one information of said distribution information and a list ID for specifying said introduction notification to information on said information distribution target person, and registers it to an introduction information management unit.

58. An information distribution device comprising: a decision means which decides an introducer who distributes information to a terminal of an information distribution target person; and
a distribution means which requests an information distribution to a terminal of said information distribution target person, to a terminal of an introducer who is decided by said decision means; wherein
said decision means
decides a related person who has a relationship with said information distribution target person as an introducer.
